(19) United States
(12) Patent Application Publication
(10) Pub. No.: US 2025/0045389 A1
(43) Pub. Date: Feb. 6, 2025

(54) ROW HAMMER MITIGATION RELIABILITY IN STACKED MEMORY ARCHITECTURES

(71) Applicant: Micron Technology, Inc., Boise, ID (US)

(72) Inventors: Chun-Yi Liu, Rancho Cordova, CA (US); Lance P. Johnson, Saint Paul, MN (US); Nathan A. Eckel, Lufkin, TX (US); James Brian Johnson, Boise, ID (US)

(21) Appl. No.: 18/763,983

(22) Filed: Jul. 3, 2024

Related U.S. Application Data
(60) Provisional application No. 63/530,910, filed on Aug. 4, 2023.

(51) Int. Cl. G06F 21/55

(52) U.S. Cl. CPC G06F 21/554; G06F 2221/034

(57) ABSTRACT

Methods, systems, and devices for row hammer mitigation reliability in stacked memory architectures are described. A spare counter may be implemented at a first interface block of a logic die to enable increased reliability and efficiency in row hammer mitigation. The first interface block may use a spare counter in case of an error associated with a counter at a memory array die. A second interface block of an array die may identify an error associated with a counter of a memory array and may transmit an indication of the error to the first interface block. The first interface block may receive the indication and may activate a spare counter to track access operations on (e.g., activations of) the row based on the indication. The first interface block may use the spare counter to evaluate whether to transmit refresh signaling to the second interface block for row hammer mitigation.

### CROSS REFERENCE

The present Application for Patent claims priority to U.S. Patent Application No. 63/530,910 by Liu et al., entitled “ROW HAMMER MITIGATION RELIABILITY IN STACKED MEMORY ARCHITECTURES,” filed Aug. 4, 2023, which is assigned to the assignee hereof, and which is expressly incorporated by reference in its entirety herein.

### TECHNICAL FIELD

The following relates to one or more systems for memory, including row hammer mitigation reliability in stacked memory architectures.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells in a non-volatile configuration may maintain stored logic states for extended periods of time even in the absence of an external power source. Memory cells in a volatile configuration may lose stored states when disconnected from an external power source.

### BRIEF DESCRIPTION OF THE DRAWINGS

FIG. 1 shows an example of a system that supports row hammer mitigation reliability in stacked memory architectures in accordance with examples as disclosed herein.

FIG. 2 shows an example of a system that supports row hammer mitigation reliability in stacked memory architectures in accordance with examples as disclosed herein.

FIG. 3 shows an example of an interface architecture that supports row hammer mitigation reliability in stacked memory architectures in accordance with examples as disclosed herein.

FIG. 4 shows an example of a system that supports row hammer mitigation reliability in stacked memory architectures in accordance with examples as disclosed herein.

FIGS. 5 through 7B show examples of processes that support row hammer mitigation reliability in stacked memory architectures in accordance with examples as disclosed herein.

FIG. 8 shows a block diagram of a logic die that supports row hammer mitigation reliability in stacked memory architectures in accordance with examples as disclosed herein.

FIG. 9 shows a block diagram of an array die that supports row hammer mitigation reliability in stacked memory architectures in accordance with examples as disclosed herein.

FIGS. 10 and 11 show flowcharts illustrating methods that support row hammer mitigation reliability in stacked memory architectures in accordance with examples as disclosed herein.

### DETAILED DESCRIPTION

Some memory systems may include a stack of semiconductor dies, including one or more memory dies above a logic die that is operable to access a set of memory arrays distributed across the one or more memory dies. Such an architecture may be implemented as part of a tightly-coupled dynamic random access memory (TCDRAM) system, and may support solutions for memory-centric logic, such as graphics processing units (GPUs), among other implementations. In some examples, a TCDRAM system may be closely coupled (e.g., physically coupled, electrically coupled) with a processor, such as a GPU or other host, as part of a physical memory map accessible to the processor. Such coupling may include one or more processors being implemented in a same semiconductor die as at least a portion of a TCDRAM system (e.g., as part of a logic die), or a processor being implemented in a die that is directly coupled (e.g., fused) with another die that includes at least a portion of a TCDRAM system. Unlike cache-based memory, TCDRAM may not be backed by a level of external memory with the same physical addresses. For example, a TCDRAM may be associated with and located within a dedicated base address, where each portion of the TCDRAM may be non-overlapping within the address.

In some memory systems that implement a stack of semiconductor dies, memory access circuitry may be distributed among (e.g., across, between) multiple semiconductor dies. For instance, multiple semiconductor dies of a TCDRAM system may include a stack of semiconductor dies (e.g., a stack of multiple directly-coupled semiconductor die), including a first die (e.g., a logic die) that is operable to access a set of memory arrays distributed across one or more second dies (e.g., array dies). In some cases, memory cells (e.g., of the set of memory arrays) may be subject to adverse accessing, such as row hammer attacks, where a row of memory cells (e.g., an aggressor row) is repeatedly accessed to adversely affect other memory cells of one or more neighboring rows (e.g., victim rows, adjacent rows). For example, repeatedly accessing a row may disturb memory cells of one or more neighboring rows such that data stored by the memory cells of the one or more neighboring rows may be modified (e.g., compromised, corrupted).

In some cases, a first interface block (e.g., a memory interface block (MIB)) of a logic die may exchange signaling (e.g., one or more signals, one or more indications) with a second interface block of an array die to perform one or more row hammer mitigation operations. For example, the second interface block may transmit alert signaling to the first interface based on a value of a counter (e.g., a per-row counter) used to track a quantity of access operations on (e.g., activations of) an address (e.g., a row) of a memory array of the array die. The alert signaling may indicate that the value of the counter satisfies one or more thresholds, which may be indicative of a row hammer attack on the row. In response to the alert signaling, the first interface block may issue one or more refresh commands to mitigate adverse effects of the row hammer attack. However, counters for evaluating potentially adverse accessing may experience errors, which may reduce reliability of adverse access mitigation techniques. For example, an error associated with a counter may cause the second interface block to be unable to identify, or to falsely identify row hammer attacks on a memory array. As such, alert signaling may not be transmitted when a row hammer attack is ongoing due to the failure to identify a row hammer attack, which may increase the risk of data corruption or modification. In some other examples, false identification of row hammer attacks may result in unnecessary transmission of alert signaling and refresh commands, which may reduce performance of a system including the logic and array dies (e.g., a TCDRAM system).

In accordance with techniques described herein, spare counters may be implemented at a logic die (e.g., as part of or coupled with a first interface block of the logic die) to support increased reliability in row hammer mitigation. For example, the first interface block may use (e.g., activate) a spare counter at the logic die (e.g., at the first interface block) in response to an error associated with a counter at an array die that is coupled with the logic die. In some examples, a second interface block of the array die may identify an error associated with a counter used to track access operations on (e.g., activations of) an address (e.g., a row) a memory array of the array die and may transmit alert signaling that includes an indication of the error to the first interface block. Based on the indication of the error, the first interface block may activate the spare counter to track access operations on the row. For example, the first interface block may increment the spare counter based on transmitting access signaling to the second interface block to access (e.g., activate) the row. While the spare counter is active, the first interface block may use the spare counter to evaluate whether to transmit refresh signaling to the second interface block for row hammer mitigation associated with the row, such as instead of based on alert signaling received from the second interface block. Implementing spare counters in accordance with the described techniques may enable a system to compensate for errors associated with counters, decrease processing and signaling overhead, reduce unnecessary refresh operations to increase system performance, and increase reliability in row hammer mitigation techniques, among other benefits.

Features of the disclosure are illustrated and described in the context of systems and dies. Features of the disclosure are further illustrated and described in the context of an interface architecture, block diagrams, and flowcharts.

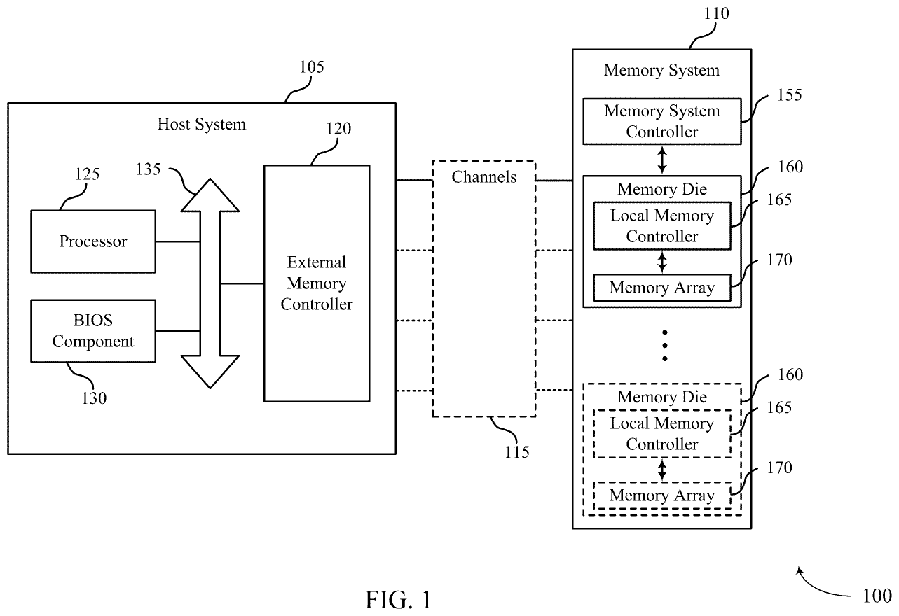

FIG. 1 illustrates an example of a system 100 that supports row hammer mitigation reliability in stacked memory architectures in accordance with examples as disclosed herein. The system 100 may include portions of an electronic device, such as a computing device, a mobile computing device, a wireless communications device, a graphics processing device, a vehicle, or other systems. The system 100 includes a host system 105, a memory system 110, and one or more channels 115 coupling the host system 105 with the memory system 110 (e.g., to provide a communicative coupling). The system 100 may include one or more memory systems 110, but aspects of the one or more memory systems 110 may be described in the context of a single memory system 110.

The host system 105 may be an example of a processor (e.g., circuitry, processing circuitry, one or more processing components) that uses memory to execute processes, such as a processing system of a computing device, a mobile computing device, a wireless communications device, a graphics processing device, a wearable device, an internet-connected device, a vehicle controller, a system on a chip (SoC), or other stationary or portable electronic device, among other examples. The host system 105 may include one or more of an external memory controller 120, a processor 125, a basic input/output system (BIOS) component 130, or other components (e.g., a peripheral component, an input/output controller, not shown). The components of the host system 105 may be coupled with one another using a bus 135.

An external memory controller 120 may be configured to enable communication of information (e.g., data, commands, control information, configuration information) between components of the system 100 (e.g., between components of the host system 105, such as the processor 125, and the memory system 110). An external memory controller 120 may process (e.g., convert, translate) communications exchanged between the host system 105 and the memory system 110. In some examples, an external memory controller 120, or other component of the system 100, or associated functions described herein, may be implemented by or be part of the processor 125. For example, an external memory controller 120 may be hardware, firmware, or software (e.g., instructions), or some combination thereof implemented by a processor 125 or other component of the system 100 or the host system 105. Although an external memory controller 120 is illustrated outside the memory system 110, in some examples, an external memory controller 120, or its functions described herein, may be implemented by one or more components of a memory system 110 (e.g., a memory system controller 155, a local memory controller 165) or vice versa. In various examples, the host system 105 or an external memory controller 120 may be referred to as a host.

A processor 125 may be operable to provide functionality (e.g., control functionality) for the system 100 or the host system 105. A processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination thereof. In some examples, a processor 125 may be an example of a central processing unit (CPU), a graphics processing unit (GPU), a general-purpose GPU (GPGPU), or an SoC, among other examples.

In some examples, the system 100 or the host system 105 may include an input component, an output component, or a combination thereof. Input components may include a sensor, a microphone, a keyboard, another processor (e.g., on a printed circuit board), an interface (e.g., a user interface, an interface between other devices), or a peripheral that interfaces with system 100 via one or more peripheral components, among other examples. Output components may include a display, audio speakers, a printing device, another processor on a printed circuit board, or a peripheral that interfaces with the system 100 via one or more peripheral components, among other examples.

The memory system 110 may be a component of the system 100 that is operable to provide physical memory locations (e.g., addresses) that may be used or referenced by the system 100. The memory system 110 may include a memory system controller 155 and one or more memory dies 160 (e.g., memory chips) to support a capacity for data storage. The memory system 110 may be configurable to work with one or more different types of host systems 105, and may respond to and execute commands provided by the host system 105 (e.g., via an external memory controller 120). For example, the memory system 110 (e.g., a memory system controller 155) may receive a write command indicating that the memory system 110 is to store data received from the host system 105, or receive a read command indicating that the memory system 110 is to provide data stored in a memory die 160 to the host system 105, or receive a refresh command indicating that the memory system 110 is to refresh data stored in a memory die 160, among other types of commands and operations.

A memory system controller 155 may include components (e.g., circuitry, logic) operable to control operations of the memory system 110. A memory system controller 155 may include hardware, firmware, or instructions that enable the memory system 110 to perform various operations, and may be operable to receive, transmit, or execute commands, data, or control information related to operations of the memory system 110. A memory system controller 155 may be operable to communicate with one or more of an external memory controller 120, one or more memory dies 160, or a processor 125. In some examples, a memory system controller 155 may control operations of the memory system 110 in cooperation with a local memory controller 165 of a memory die 160.

Each memory die 160 may include a local memory controller 165 and a memory array 170. A memory array 170 may be a collection of memory cells, with each memory cell being operable to store one or more bits of data. A memory die 160 may include a two-dimensional (2D) array of memory cells, or a three-dimensional (3D) array of memory cells. In some examples, a 2D memory die 160 may include a single memory array 170. In some examples, a 3D memory die 160 may include two or more memory arrays 170, which may be stacked or positioned beside one another (e.g., relative to a substrate).

A local memory controller 165 may include components (e.g., circuitry, logic) operable to control operations of a memory die 160. In some examples, a local memory controller 165 may be operable to communicate (e.g., receive or transmit data or commands or both) with a memory system controller 155. In some examples, a memory system 110 may not include a memory system controller 155, and a local memory controller 165 or an external memory controller 120 may perform various functions described herein. As such, a local memory controller 165 may be operable to communicate with a memory system controller 155, with other local memory controllers 165, or directly with an external memory controller 120, or a processor 125, or any combination thereof. Examples of components that may be included in a memory system controller 155 or a local memory controller 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, sense components for sensing states of memory cells of a memory array 170, write components for writing states to memory cells of a memory array 170, or various other components operable for supporting described operations of a memory system 110.

A host system 105 (e.g., an external memory controller 120) and a memory system 110 (e.g., a memory system controller 155) may communicate information (e.g., data, commands, control information, configuration information) using one or more channels 115. Each channel 115 may be an example of a transmission medium that carries information, and each channel 115 may include one or more signal paths (e.g., a transmission medium, an electrical conductor, an electrically conductive path) between terminals associated with the components of the system 100. For example, a channel 115 may be associated with a first terminal (e.g., including one or more pins, including one or more pads) at the host system 105 and a second terminal at the memory system 110. A terminal may be an example of a conductive input or output point of a device of the system 100, and a terminal may be operable to act as part of a channel 115. In some implementations, at least the channels 115 between a host system 105 and a memory system 110 may include or be referred to as a host interface (e.g., a physical host interface). In some implementations, a host interface may include or be associated with interface circuitry (e.g., signal drivers, signal latches) at the host system 105 (e.g., at an external memory controller 120), or at the memory system 110 (e.g., at a memory system controller 155), or both.

In some examples, a channel 115 (e.g., associated signal paths and terminals) may be dedicated to communicating one or more types of information. For example, the channels 115 may include one or more command and address channels, one or more clock signal channels, one or more data channels, among other channels or combinations thereof. In some examples, signaling may be communicated via the channels 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols of a signal may be registered for each clock cycle (e.g., on both a rising edge and a falling edge of a clock signal).

In some examples, at least a portion of the system 100 may implement a stacked die architecture in which multiple semiconductor dies are physically and communicatively coupled. In some implementations, one or more semiconductor dies may include multiple instances of interface circuitry (e.g., of a memory system 110, memory interface blocks) that are each associated with accessing a respective set of one or more memory arrays 170 of one or more other semiconductor dies. In some cases, circuitry for accessing one or more memory arrays 170 may be distributed among multiple semiconductor dies of a stack (e.g., a stack of multiple directly-coupled semiconductor dies). For example, a first die may include a logic block (e.g., a common logic block, a central logic block, logic circuitry) operable to configure a set of multiple first interface blocks (e.g., MIBs, instances of first interface circuitry) of the first die. In some examples, the system may include a respective controller (e.g., a memory controller, a host interface controller, at least a portion of a memory system controller 155, at least a portion of an external memory controller 120, or a combination thereof) for each first interface block to support access operations (e.g., to access one or more memory arrays 170) via the first interface block. The system 100 may also include non-volatile storage, one or more sensors, or a combination thereof to support various operations of the system 100.

In some examples, multiple semiconductor dies of a memory system 110 (e.g., a TCDRAM system) may include one or more second dies (e.g., memory dies 160, array dies) stacked with a first die (e.g., a logic die that includes the host system 105, a logic die that is coupled with a third die that includes the host system 105) that includes interface blocks operable to access a set of memory arrays 170 distributed across the one or more second dies. In some cases, memory cells in the set of memory arrays 170 may be subject to adverse accessing, such as a row hammer attack. To mitigate (e.g., avoid, reduce) adverse effects resulting from row hammer attacks, the memory system 110 may distribute techniques for row hammer mitigation across circuitry of the memory system 110. In some cases, a counter associated with a row of a memory array 170 may enable the memory system 110 to identify a row hammer attack on the row and transmit alert signaling to an interface block of a logic die to support row hammer mitigation operations associated with the row. However, some counters used for monitoring row hammer attacks may experience errors. For example, one or more bits of the counter may be stuck in a logic state (e.g., either ‘1’ or ‘0’) or may experience transient bit flips. Such counter errors may reduce a reliability of row hammer mitigation operations, such as by causing failure to identify or false identification of row hammer attacks on a memory array.

In accordance with techniques described herein, spare counters may be implemented at a first interface block of a logic die to support increased reliability in row hammer mitigation. For example, the first interface block may use (e.g., activate) a spare counter at the logic die in response to an error associated with a counter at an array die that is coupled with the array die. For instance, the first interface block may receive, from a second interface block at the array die, an indication of an error associated with a counter for counting access operations on (e.g., activations of) a row of a memory array 170. Based on receiving the indication, the first interface block may activate a spare counter to track (e.g., count) activations of the row. The first interface block may use the spare counter to evaluate whether to transmit refresh signaling to refresh one or more neighboring rows of the row, for example, instead of evaluating whether to transmit refresh signaling based on alert signaling from the second interface block. Implementing spare counters and techniques described herein may compensate for errors associated with counters, decrease processing and signaling overhead, reduce unnecessary refresh operations to increase system performance, and increase reliability of row hammer mitigation techniques at the memory system 110.

In addition to applicability in memory systems as described herein, techniques for row hammer mitigation reliability in stacked memory architectures may be generally implemented to support artificial intelligence applications. As the use of artificial intelligence increases to support machine learning, analytics, decision making, or other related applications, electronic devices that support artificial intelligence applications and processes may be desired. For example, artificial intelligence applications may be associated with accessing relatively large quantities of data for analytical purposes and may benefit from memory devices capable of effectively and efficiently storing relatively large quantities of data or accessing stored data relatively quickly. Implementing the techniques described herein may support artificial intelligence or machine learning techniques by supporting robust protection of information accessed via a relatively high quantity of closely-coupled interfaces (e.g., channels, data paths, support stacks) between a host and memory arrays of one or more semiconductor dies that are stacked over a logic die, such as by increasing reliability and efficiency of row hammer mitigation operations, among other benefits.

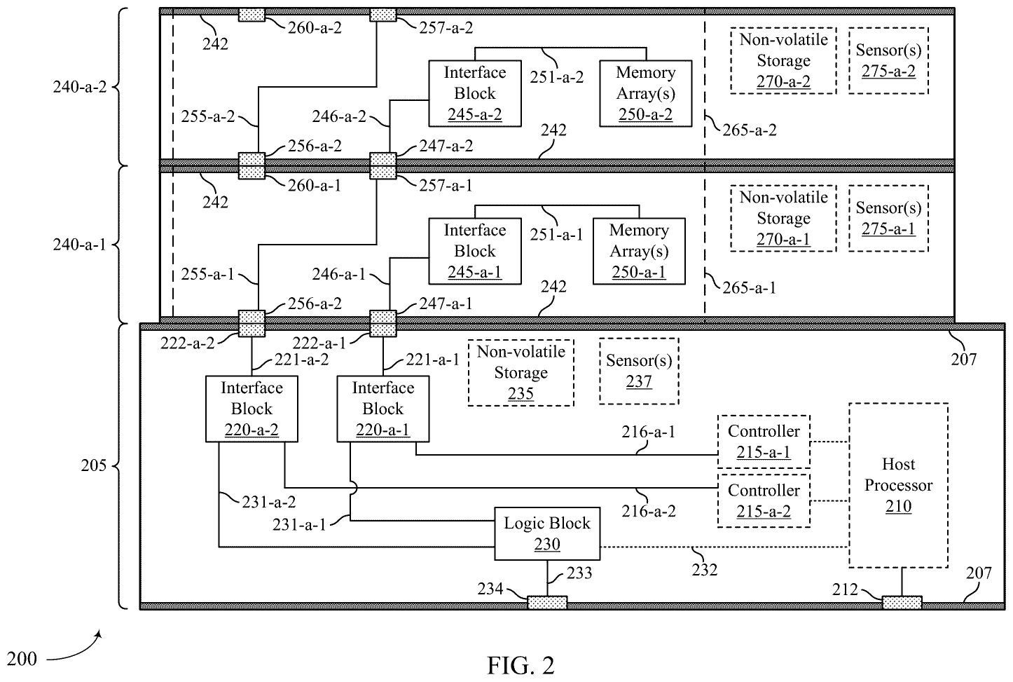

FIG. 2 illustrates an example of a system 200 (e.g., a semiconductor system, a system of coupled semiconductor dies) that supports row hammer mitigation reliability in stacked memory architectures in accordance with examples as disclosed herein. The system 200 illustrates an example of a die 205 (e.g., a semiconductor die, a host die, a processor die, a logic die) that is coupled with one or more dies 240 (e.g., dies 240-a-1 and 240-a-2, semiconductor dies, memory dies, array dies). A die 205 or a die 240 may be formed using a respective semiconductor substrate (e.g., a substrate of crystalline semiconductor material such as silicon, germanium, silicon-germanium, gallium arsenide, or gallium nitride), or a silicon-on-insulator (SOI) substrate (e.g., silicon-on-glass (SOG), silicon-on-sapphire (SOS)), or epitaxial semiconductor materials formed on another substrate, among other examples. Although the illustrated example of a system 200 includes two dies 240, a system 200 in accordance with the described techniques may include any quantity of one or more dies 240 coupled with a die 205. Further, although non-limiting examples of the system 200 herein are generally described in terms of applicability to memory systems, memory sub-systems, memory devices, or a combination thereof, examples of the system 200 are not so limited. For example, aspects of the present disclosure may be applied as well to any computing system, computing sub-system, processing system, processing sub-system, component, device, structure, or other types of systems or sub-systems used for applications such as data collecting, data processing, data storage, networking, communication, power, artificial intelligence, system-on-a-chip, control, telemetry, sensing and monitoring, digital entertainment, or any combination thereof.

The system 200 illustrates an example of interface circuitry between a host and memory (e.g., via a host interface, via a physical host interface) that is implemented in (e.g., divided between) multiple semiconductor dies (e.g., a stack of directly coupled dies). For example, the die 205 may include a set of one or more interface blocks 220 (e.g., interface blocks 220-a-1 and 220-a-2, memory interface blocks), and each die 240 may include a set of one or more interface blocks 245 and one or more memory arrays 250 (e.g., die 240-a-1 including an interface block 245-a-1 coupled with a set of one or more memory arrays 250-a-1, die 240-a-2 including an interface block 245-a-2 coupled with a set of one or more memory arrays 250-a-2). The memory arrays 250 may be examples of memory arrays 170, and may include memory cells of various architectures, such as RAM, DRAM, SDRAM, SRAM, FeRAM, MRAM, RRAM, PCM, chalcogenide, NOR, or NAND memory cells, or any combination thereof.

Although the example of system 200 is illustrated with one interface block 245 included in each die 240, a die 240 in accordance with the described techniques may include any quantity of one or more interface blocks 245, each coupled with a respective set of one or more memory arrays 250, and each coupled with a respective interface block 220 of a die 205. Thus, the interface circuitry of a system 200 may include one or more interface blocks 220 of a die 205, with each interface block 220 being coupled with (e.g., in communication with) a corresponding interface block 245 of a die 240 (e.g., external to the die 205). In some examples, a coupled combination of an interface block 220 and an interface block 245 (e.g., coupled via a bus associated with one or more channels, such as one or more data channels, one or more control channels, one or more clock channels, or a combination thereof) may include or be referred to as a data path associated with a respective set of one or more memory arrays 250.

In some implementations, the die 205 may include a host processor 210. A host processor 210 may be an example of a host system 105, or a portion thereof (e.g., a processor 125, aspects of an external memory controller 120, or both). The host processor 210 may be configured to perform operations that implement storage of the memory arrays 250. For example, the host processor 210 may receive data read from the memory arrays 250, or may transmit data to be written to the memory arrays 250, or both (e.g., in accordance with an application or other operations of the host processor 210). Additionally, or alternatively, a host processor 210 may be external to a die 205, such as in another semiconductor die or other component that is coupled with (e.g., communicatively coupled with, directly coupled with, bonded with) the die 205 via one or more contacts 212.

A host processor 210 may be configured to communicate (e.g., transmit, receive) signaling with the interface blocks 220 via one or more host interfaces 216 (e.g., a physical host interface), which may implement aspects of channels 115 described with reference to FIG. 1. For example, the host processor 210 may be configured to transmit access signaling (e.g., control signaling, access command signaling, configuration signaling) via host interfaces 216, which may be received by the interface blocks 220 to support access operations (e.g., read operations, write operations) on the memory arrays 250. In some examples, a host interface 216 may include a respective set of one or more signal paths for each interface block 220, such that the host processor 210 may communicate with each interface block 220 via the respective set of signal paths (e.g., in accordance with a selection of the respective set to perform access operations via an interface block 220 that is selected by the host processor 210). Additionally, or alternatively, a host interface 216 may include one or more signal paths that are shared among multiple interface blocks 220 (not shown), and an interface block 220, or a host processor 210, or both may interpret, ignore, respond to, or inhibit response to signaling via shared signal paths of the host interface 216 based on a logical indication (e.g., an addressing indication associated with the interface block 220 or an interface enable signal, which may be provided by the host processor 210 or the corresponding interface block 220, depending on signaling direction).

In some examples, a respective host interface 216 may be coupled between a set of one or more interface blocks 220 and a controller 215 (e.g., host interface 216-a-1 coupled between interface block 220-a-1 and controller 215-a-1, host interface 216-a-2 coupled between interface block 220-a-2 and controller 215-a-2). The one or more interface blocks 220 and the controller 215 may communicate (e.g., collaborate) to perform one or more operations (e.g., scheduling operations, access operations, operations initiated by a host processor 210) associated with a memory array 250. A controller 215 may be an example of control circuitry (e.g., memory controller circuitry, host interface control circuitry), and may be associated with implementing respective instances of one or more aspects of an external memory controller 120, or of a memory system controller 155, or a combination thereof for each interface block 220. In some examples, controllers 215 may be implemented in a die 205 whether a host processor 210 is included in the die 205, or is external to the die 205, and the interface block 220 may communicate with the host processor 210 via one or more controllers 215. In some other examples, controllers 215 may be implemented external to a die 205 (e.g., in another die, not shown, coupled with respective interface blocks 220 via respective terminals for each of the respective host interfaces 216), which may be in a same die as or a different die from a die that includes a host processor 210. In some other examples, aspects of one or more controllers 215 may be included in the host processor 210. Although the example of system 200 is illustrated as including a controller 215 for each interface block 220, in various examples, a controller 215 may be coupled with any quantity of one or more interface blocks 220, and a given interface block 220 may be operable based on single controller 215, or by one or more of a set of multiple controllers 215 (e.g., in accordance with a controller multiplexing scheme).

In some examples, a host processor 210 may determine to access an address (e.g., a logical address of a memory array 250, a physical address of a memory array 250, an address of an interface block 220), and determine which controller 215 to transmit access signaling to for accessing the address (e.g., a controller 215 or interface block 220 corresponding to the address). In some examples, the address may be associated with a row of memory cells of the memory array 250. The host processor 210 may transmit access signaling to the determined controller 215 and, in turn, the determined controller 215 may transmit access signaling to the corresponding interface block 220. The corresponding interface block 220 may subsequently transmit access signaling to the coupled interface block 245 to access the determined address (e.g., in a corresponding memory array 250).

A die 205 may also include a logic block 230 (e.g., a shared logic block, a central logic block, common logic circuitry), which may be configured to communicate (e.g., transmit, receive) signaling with the interface blocks 220 of the die 205. In some cases, the logic block 230 may be configured to communicate information (e.g., commands, instructions, indications, data) with one or more interface blocks 220 to facilitate operations of the system 200. For example, a logic block 230 may be configured to transmit configuration signaling (e.g., initialization signaling, evaluation signaling), which may be received by interface blocks 220 to support configuration of the interface blocks 220 or other aspects of operating the dies 240 (e.g., via the respective interface blocks 245). A logic block 230 may be coupled with each interface block 220 via a respective bus 231 (e.g., bus 231-a-1 associated with the interface block 220-a-1, bus 231-a-2 associated with the interface block 220-a-2). In some examples, respective buses 231 may each include a respective set of one or more signal paths, such that a logic block 230 may communicate with each interface block 220 via the respective set of signal paths. Additionally, or alternatively, respective buses 231 may include one or more signal paths that are shared among multiple interface blocks 220 (not shown).

In some implementations, a logic block 230 may be configured to communicate (e.g., transmit, receive) signaling with a host processor 210 (e.g., via a bus 232, via a contact 212 for a host processor 210 external to a die 205) such that the logic block 230 may support an interface between the interface blocks 220 and the host processor 210. For example, a host processor 210 may be configured to transmit initialization signaling (e.g., boot commands), or other configuration or operational signaling, which may be received by a logic block 230 to support initialization, configuration, or other operations of the interface blocks 220. Additionally, or alternatively, in some implementations, a logic block 230 may be configured to communicate (e.g., transmit, receive) signaling with a component outside the system 200 via a bus 233 (e.g., and via a contact 234), such that the logic block 230 may support an interface that bypasses a host processor 210. Additionally, or alternatively, a logic block 230 may communicate with a host processor 210, and may communicate with one or more memory arrays 250 of one or more dies 240 (e.g., to perform self-test operations for the memory arrays 250). In some examples, such implementations may support evaluations, configurations, or other operations of the system 200, via contacts 234 that are accessible at a physical interface of the system, during manufacturing, assembly, validation, or other operation associated with the system 200 (e.g., before coupling with a host processor 210, without implementing a host processor 210, for operations independent of a host processor).

Each interface block 220 may be coupled with at least a respective bus 221 of the die 205, and a respective bus 246 of a die 240, that are configured to communicate signaling with a corresponding interface block 245 (e.g., via one or more associated signal paths). For example, the interface block 220-a-1 may be coupled with the interface block 245-a-1 via a bus 221-a-1 and a bus 246-a-1, and the interface block 220-a-2 may be coupled with the interface block 245-a-2 via a bus 221-a-2 and a bus 246-a-2. In some examples, a die 240 may include a bus that bypasses operational circuitry of the die 240 (e.g., bypasses interface blocks 245 of a given die 240), such as a bus 255. For example, the interface block 220-a-2 may be coupled with the interface block 245-a-2 of the die 240-a-2 via a bus 255-a-1 of the die 240-a-1, which may bypass interface blocks 245 of the die 240-a-1. Such techniques may be extended for interconnection among more than two dies 240 (e.g., for interconnection via a respective bus 255 of multiple dies 240).

The respective signal paths of buses 221, 246, and 255 may be coupled with one another, from one die to another, via various arrangements of contacts at the surfaces of interfacing dies. For example, the bus 221-a-1 may be coupled with the bus 246-a-1 via a contact 222-a-1 of (e.g., at a surface of) the die 205 and a contact 247-a-1 of the die 240-a-1, the bus 221-a-2 may be coupled with the bus 255-a-1 via a contact 222-a-2 of the die 205 and a contact 256-a-1 of the die 240-a-1, the bus 255-a-1 may be coupled with the bus 246-a-2 via a contact 257-a-1 of the die 240-a-1 and a contact 247-a-2 of the die 240-a-2, and so on. Although each respective bus is illustrated with a single line, coupled via singular contacts, it is to be understood that each signal path of a given bus may be associated with respective contacts to support a separate communicative coupling via each signal path of the given bus. In some examples, a bus 255 may traverse a portion of a die 240 (e.g., in an in-plane direction, along a direction different from a thickness direction, in a waterfall arrangement), which may support an arrangement of contacts 222 along a surface of a die 205 being coupled with interface blocks 245 of different dies 240 along a stack direction (e.g., via respective contacts 256 and 257 that are non-overlapping when viewed along a thickness direction).

The interconnection of interfacing contacts may be supported by various techniques. For example, in a hybrid bonding implementation, interfacing contacts may be coupled by a fusion of conductive materials (e.g., electrically conductive materials) of the interfacing contacts (e.g., without solder or other intervening material between contacts). For example, in an assembled condition, the coupling of the die 205 with the die 240-a-1 may include a conductive material of the contact 222-a-2 being fused with a conductive material of the contact 256-a-1, and the coupling of the die 240-a-1 with the die 240-a-2 may include a conductive material of the contact 257-a-1 being fused with a conductive material of the contact 247-a-2, and so on. In some examples, such coupling may include an inoperative fusion of contacts (e.g., a non-communicative coupling, a physical coupling), such as a fusion of the contact 260-a-1 with the contact 256-a-2, neither of which are coupled with operative circuitry of the dies 240-a-1 or 240-a-2. In some examples, such techniques may be implemented to improve coupling strength or uniformity (e.g., implementing contacts 260, which may not be operatively coupled with an interface block 245 or an interface block 220), or such a coupling may be a byproduct of a repetition of components that, in various configurations, may be operative or inoperative. (e.g., where, for dies 240 with a common arrangement of contacts 256 and 257, contacts 256-a-1 and 257-a-1 provide a communicative path between the interface block 245-a-2 and the interface block 220-a-2, but the contacts 256-a-2 and 257-a-2 do not provide a communicative path between an interface block 245 and an interface block 220).

In some examples, a fusion of conductive materials between dies (e.g., between contacts) may be accompanied by a fusion of other materials at one or more surfaces of the interfacing dies. For example, in an assembled condition, the coupling of the die 205 with the die 240-a-1 may include a dielectric material 207 (e.g., an electrically non-conductive material) of the die 205 being fused with a dielectric material 242 of the die 240-a-1, and the coupling of the die 240-a-1 with the die 240-a-2 may include a dielectric material 242 of the die 240-a-1 being fused with a dielectric material 242 of the die 240-a-2. In some examples, such dielectric materials may include an oxide, a nitride, a carbide, an oxide-nitride, an oxide-carbide, or other conversion or doping of a semiconductor material of the die 205 or dies 240, among other materials that may support such fusion. However, coupling among dies 205 and dies 240 may be implemented in accordance with other techniques, which may implement solder, adhesives, thermal interface materials, and other intervening materials.

In some examples, dies 240 may be coupled in a stack (e.g., forming a “cube” or other arrangement of dies 240), and the stack may subsequently be coupled with a die 205. In some examples, a respective set of one or more dies 240 may be coupled with each die 205 of multiple dies 205 formed in a wafer (e.g., in a chip-to-wafer bonding arrangement, before cutting the wafer of dies 205), and the dies 205, coupled with their respective set of dies 240, may be separated from one another (e.g., by cutting at least the wafer of dies 205). In some other examples, a respective set of one or more dies 240 may be coupled with a respective die 205 after the die 205 is separated from a wafer of dies 205 (e.g., in a chip-to-chip bonding arrangement).

The buses 221, 246, and 255 may be configured to provide a configured signaling (e.g., a coordinated signaling, a logical signaling, modulated signaling, digital signaling) between an interface block 220 and a corresponding interface block 245, which may involve various modulation or encoding techniques by a transmitting interface block (e.g., via a driver component of the transmitting interface block). In some examples, such signaling may be supported by (e.g., accompanied by) clock signaling communicated via the respective buses (e.g., in coordination with signal transmission). For example, the buses may be configured to convey one or more clock signals transmitted by the interface block 220 for reception by the interface block 245 (e.g., to trigger signal reception by a latch or other reception component of the interface block 245, to support clocked operations of the interface block 245). Additionally, or alternatively, the buses may be configured to convey one or more clock signals transmitted by the interface block 245 for reception by the interface block 220 (e.g., to trigger signal reception by a latch or other reception component of the interface block 220, to support clocked operations of the interface block 220). Such clock signals may be associated with the communication (e.g., unidirectional communication, bidirectional communication) of various signaling, such as control signaling, command signaling, data signaling, or any combination thereof. For example, the buses may include one or more signal paths for communications of a data bus (e.g., one or more data channels, a DQ bus, via a data interface of the interface blocks) in accordance with one or more corresponding clock signals (e.g., data clock signals), or one or more signal paths for communications of a control bus (e.g., a command/address (C/A) bus, via a command interface of the interface blocks) in accordance with one or more clock signals (e.g., control clock signals), or any combination thereof.

Interface blocks 220, interface blocks 245, and logic block 230 each may include circuitry (signaling circuitry, multiplexing circuitry, processing circuitry, controller circuitry) in various configurations (e.g., hardware configurations, logic configurations, software or instruction configurations) that support the functionality allocated to the respective block for accessing or otherwise operating a corresponding set of memory arrays 250. For example, interface blocks 220 may include circuitry configured to perform a first subset of operations that support access of the memory arrays 250, and interface blocks 245 may include circuitry configured to support a second subset of operations that support access of the memory arrays 250. In some examples, the interface blocks 220 and 245 may support a functional split or distribution of functionality associated with a memory system controller 155, a local memory controller 165, or both across multiple dies (e.g., a die 205 and at least one die 240). In some implementations, a logic block 230 may be configured to coordinate or configure aspects of the operations of the interface blocks 220, of the interface blocks 245, or both, and may support implementing one or more aspects of a memory system controller 155. Such operations, or subsets of operations, may include operations performed in response to commands from the host processor 210, or operations performed without commands from the host processor 210 (e.g., operations determined or initiated by an interface block 220, operations determined or initiated by an interface block 245, operations determined or initiated by a logic block 230), or various combinations thereof.

In some implementations, the system 200 may include one or more instances of non-volatile storage (e.g., non-volatile storage 235 of a die 205, non-volatile storage 270 of one or more dies 240, or a combination thereof). In some examples, a logic block 230, interface blocks 220, interface blocks 245, or a combination thereof may be configured to communicate signaling with one or more instances of non-volatile storage. For example, a logic block 230, interface blocks 220, or interface blocks 245 may be coupled with one or more instances of non-volatile storage via one or more buses (not shown), or respective contacts (not shown), where applicable, which may each include one or more signal paths operable to communicate signaling (e.g., command signaling, data signaling). In some examples, a logic block 230, one or more interface blocks 220, one or more interface blocks 245, or a combination thereof may configure one or more operations based on information stored in one or more instances of non-volatile storage. Additionally, or alternatively, in some examples, a logic block 230, one or more interface blocks 220, one or more interface blocks 245, or a combination thereof may write information (e.g., configuration information) to be stored in one or more instances of non-volatile storage.

In some implementations, the system 200 may include one or more sensors (e.g., one or more sensors 237 of a die 205, one or more sensors 275 of one or more dies 240, or a combination thereof). In some implementations, a logic block 230, interface blocks 220, interface blocks 245, or a combination thereof may be configured to receive one or more indications based on measurements of one or more sensors of the system 200. For example, a logic block 230, interface blocks 220, or interface blocks 245 may be coupled with one or more sensors via one or more buses (not shown), or respective contacts (not shown). Such sensors may include temperature sensors, current sensors, voltage sensors, counters, and other types of sensors. In some examples, a logic block 230, one or more interface blocks 220, one or more interface blocks 245, or a combination thereof may configure one or more operations based on output of the one or more sensors. For example, a logic block 230 may configure one or more operations of interface blocks 220 based on signaling (e.g., indications, data) received from the one or more sensors. Additionally, or alternatively, an interface block 220 may generate access signaling for transmitting to a corresponding interface block 245 based on one or more sensors.

In some examples, circuitry of interface blocks 220, interface blocks 245, or a logic block 230, or any combination thereof may include components (e.g., transistors) formed at least in part from doped portions of a substrate of the respective die. In some examples, a substrate of a die 205 may have characteristics that are different from those of a substrate of a die 240. Additionally, or alternatively, in some examples, transistors formed from a substrate of a die 205 may have characteristics that are different from transistors formed from a substrate of a die 240 (e.g., in accordance with different transistor architectures).

In some examples, the interface blocks 220 may support a layout for one or more components within the 220. For example, the layout may include pairing components to share an access port (e.g., a command port, a data port). Further, in some examples, the layout may support interfaces for a controller 215 (e.g., a host interface 216) that are different from interfaces for an interface block 245 (e.g., via the buses 221). For instance, a host interface 216 may be synchronous and have separate channels for read and write operations, while an interface via buses 221 and 246 may be asynchronous and support both read and write operations with a same channel.

A die 240 may include one or more units 265 (e.g., modules) that are separated from a semiconductor wafer having a pattern (e.g., a two-dimensional pattern) of units 265. Although each die 240 of the system 200 is illustrated with a single unit 265 (e.g., unit 265-a-1 of die 240-a-1, unit 265-a-2 of die 240-a-2), a die 240 in accordance with the described techniques may include any quantity of units 265, which may be arranged in various patterns (e.g., sets of one or more units 265 along a row direction, sets of one or more units 265 along a column direction, among other patterns). Each unit 265 may include at least the circuitry of a respective interface block 245, along with memory array(s) 250, a bus 251, a bus 246, and one or more contacts 247 corresponding to the respective interface block 245. In some examples, where applicable, each unit 265 may also include one or more buses 255, contacts 256, contacts 257, or contacts 260 (e.g., associated with a respective interface block 245 of a unit 265 of a different die 240), which may support various degrees of stackability or modularity among or via units 265 of other dies 240.

In some examples, the interface blocks 220 may include circuitry configured to receive first access command signaling from a host processor 210 or a controller 215 (e.g., via a host interface 216, via one or more contacts 212 from a host processor 210 or controller 215 external to a die 205), and to transmit second access command signaling to the respective (e.g., coupled) interface block 245 based on (e.g., in response to) the received first access command signaling. The interface blocks 245 may accordingly include circuitry configured to receive the second access command signaling from the respective interface block 220 and, in some examples, to access a respective set of one or more memory arrays 250 based on (e.g., in response to) the received second access command signaling. In various examples, the first access command signaling may include access commands that are associated with a type of operation (e.g., a read operation, a write operation, a refresh operation, a memory management operation), which may be associated with an indication of an address of the one or more memory arrays 250 (e.g., a logical address, a physical address). In some examples, the first access command signaling may include an indication of a logical address associated with the memory arrays 250, and circuitry of an interface block 220 may be configured to generate the second access command signaling to indicate a physical address associated with the memory arrays 250 (e.g., a row address, a column address, using a logical-to-physical (L2P) table or other mapping or calculation functionality of the interface block 220).

In some examples, to support write operations of the system 200, circuitry of the interface blocks 220 may be configured to receive (e.g., from a host processor 210, from a controller 215, via a host interface 216, via one or more contacts 212 from a host processor 210 or controller 215 external to a die 205) first data signaling associated with the first access command signaling, and to transmit second data signaling (e.g., associated with second access command signaling) based on received first access command signaling and first data signaling. The interface blocks 245 may accordingly be configured to receive second data signaling, and to write data to one or more memory arrays 250 (e.g., in accordance with an indicated address associated with the first access command signaling) based on the received second access command signaling and second data signaling. In some examples, the interface blocks 220 may include an error control functionality (e.g., error detection circuitry, error correction circuitry, error correction code (ECC) logic, an ECC engine) that supports the interface blocks 220 generating the second data signaling based on performing an error control operation using the received first data signaling (e.g., detecting or correcting an error in the first data signaling, determining one or more parity bits to be conveyed in the second data signaling and written with the data).

In some examples, to support read operations of the system 200, circuitry of the interface blocks 245 may be configured to read data from the memory arrays 250 based on received second access command signaling, and to transmit first data signaling based on the read data. The interface blocks 220 may accordingly be configured to receive first data signaling, and to transmit second data signaling (e.g., to a host processor 210, to a controller 215, via a host interface 216, via one or more contacts 212 to a host processor 210 or controller 215 external to a die 205) based on the received first data signaling. In some examples, the interface blocks 220 may include an error control functionality that supports the interface blocks 220 generating the second data signaling based on performing an error control operation using the received first data signaling (e.g., detecting or correcting an error in the first data signaling, which may include a calculation involving one or more parity bits received with the first data signaling).

In some examples, access command signaling that is transmitted by the interface blocks 220 to the interface blocks 245, among other signaling, may be generated (e.g., based on access command signaling received from a host processor 210, based on initiation signaling received from a host processor 210, without receiving or otherwise independent from signaling from a host processor 210) in accordance with various determination or generation techniques configured at the interface blocks 220 (e.g., based on a configuration for accessing memory arrays 250 that is modified at the interface blocks 220). In some examples, such techniques may involve signaling or other coordination with a logic block 230, a host processor 210, one or more controllers 215, one or more instances of non-volatile storage, one or more sensors, or any combination thereof. Such techniques may support the interface blocks 220 configuring aspects of the access operations performed on the memory arrays 250 by a respective interface block 245, among other operations. For example, interface blocks 220 may include evaluation circuitry, access configuration circuitry, signaling circuitry, scheduling circuitry, repair circuitry, refresh circuitry, error control circuitry, adverse access circuitry, and other circuitry operable to configure operations associated with one or more dies (e.g., operations associated with accessing memory arrays 250 of the dies 240).

In some cases, memory cells in the memory arrays 250 may be subject to adverse accessing, such as a row hammer attack, which may modify (e.g., compromise, corrupt) data stored by the memory cells. For example, as part of a row hammer attack, a row of memory cells (e.g., an aggressor row) of a memory array 250 may undergo repeated activations in a relatively short duration, which may adversely affect logic states stored by memory cells in one or more rows neighboring the aggressor row. To mitigate adverse effects of row hammer attacks, a counter associated with a row of a memory array 250, such as a counter included in or coupled with the memory array 250, may count (e.g., monitor, track) a quantity of access operations on (e.g., activations of) the row and identify when the quantity of access operations satisfies (e.g., meets, exceeds) one or more threshold values. However, counters for evaluating potentially adverse accessing may experience errors, which may reduce reliability of adverse access mitigation techniques.

In accordance with techniques described herein, spare counters may be implemented by an interface block 220 of a die 205 to support increased reliability in row hammer mitigation and compensate for errors of counters at a die 240. For example, an interface block 220 may activate and use a spare counter in response to an error associated with a counter at a memory array 250. For instance, the interface block 220 may receive, from an interface block 245, alert signaling that indicates an error associated with a counter of the corresponding die 240 for counting activations of a row. Based on the alert signaling indicating the error, the interface block 220 may activate a spare counter to track activations of the row. The interface block 220 may use the spare counter to evaluate whether to transmit refresh signaling to the interface block 245 for row hammer mitigation (e.g., while the spare counter remains activated). Using spare counters and techniques described herein may increase reliability and efficiency associated with row hammer mitigation techniques at the system 200.

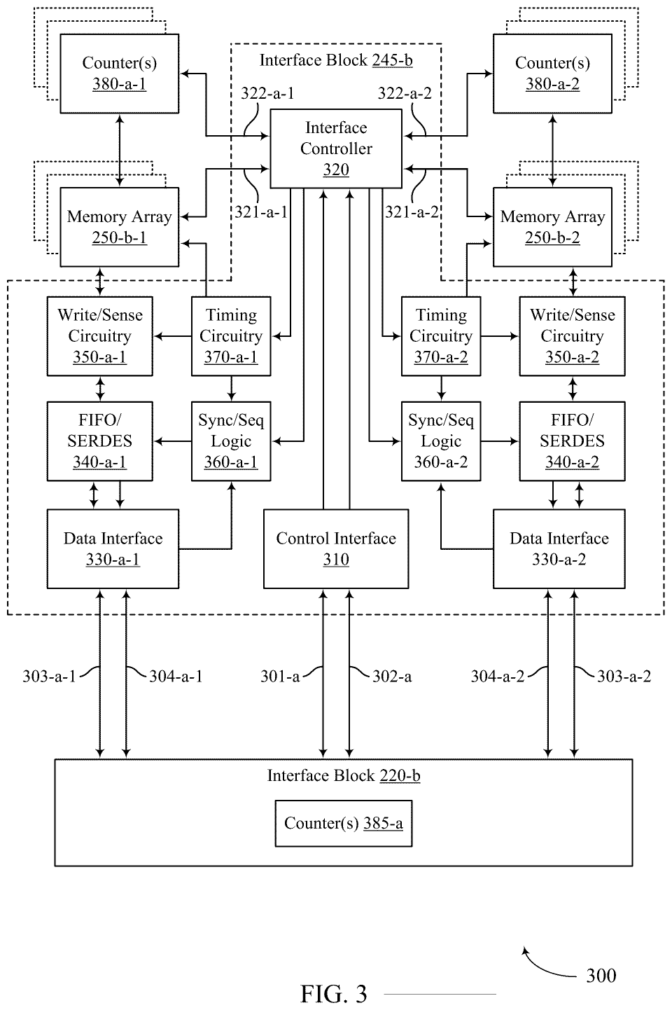

FIG. 3 shows an example of an interface architecture 300 that supports row hammer mitigation reliability in stacked memory architectures in accordance with examples as disclosed herein. The interface architecture 300 illustrates an example of an interface block 245-b (e.g., of a die 240) coupled with an interface block 220-b (e.g., of a die 205). The interface block 245-b may be communicatively coupled with the interface block 220-b via one or more of a bus 301, a bus 302, a bus 303, and a bus 304, each of which may be examples of one or more signal paths of a bus 221 and a bus 246, as well as a bus 255, where applicable.

The interface block 245-b includes a control interface 310 (e.g., a command interface), which may be configured to communicate signaling with the interface block 220-b. For example, the control interface 310 may include circuitry (e.g., a receiver, one or more latches) configured to receive control signaling (e.g., modulated control signaling, access command signaling, configuration signaling, address signaling, such as row address signaling or column address signaling) via the bus 301-a. The control interface 310 also may include circuitry configured to receive clock signaling (e.g., clock signaling associated with the control interface 310, clock signaling having one or more phases, such as true and complement phases, dk_t/c signaling from the interface block 220-b) via the bus 302-a, which the control interface 310 may use for receiving the control signaling of the bus 301-a (e.g., for triggering the one or more latches). The control interface 310 may transmit (e.g., forward) the control signaling the clock signaling (e.g., for timing of other operations of the interface block 245-b) to an interface controller 320.

The interface block 245-b also includes two data interfaces 330 (e.g., data interfaces 330-a-1 and 330-a-2), which also may be configured to communicate signaling with the interface block 220-b. Each data interface 330 may include corresponding buses and circuitry, the operation of which may be associated with (e.g., controlled by, coordinated with, operated based on) control signaling via the control interface 310. Although the example of interface block 245-b includes two such data interfaces 330 associated with the control interface 310 (e.g., in a “channel pair” arrangement), the described techniques for an interface block 245 may include any quantity of one or more data interfaces 330, and associated buses and circuitry, for a given control interface 310 of the interface block 245. Each data interface 330 may be associated with respective data path circuitry, which may include respective first-in-first-out (FIFO) and serialization/deserialization (SERDES) circuitry (e.g., FIFO/SERDES 340), respective write/sense circuitry 350, respective synchronization and sequencing circuitry (e.g., sync/seq logic 360), and respective timing circuitry 370, along with interconnecting signal paths (e.g., one or more buses). However, in some other examples, data path circuitry may be arranged in a different manner, or may include different circuitry components, which may include circuitry that is dedicated to respective data paths, or shared among data paths, or various combinations thereof. Each data interface 330 also may be associated with a respective set of one or more memory arrays 250. In some examples, each memory array 250 may be understood to include respective addressing circuitry such as bank logic or decoders (e.g., a row decoder, a column decoder), among other array circuitry. However, in some other examples, at least a portion of such circuitry may be included in an interface block 245.

Each data interface 330 may include circuitry (e.g., one or more latches, one or more drivers) configured to communicate (e.g., receive, transmit) data signaling (e.g., modulated data signaling, DQ signaling) via a respective bus 303. Each data interface 330 also may include circuitry to communicate clock signaling via a respective bus 304, which may support clock signal reception by the data interface 330 (e.g., first clock signaling associated with the data interface 330, clock signaling having one or more phases, such as true and complement phases, DQS_t/c signaling from the interface block 220-b, clock signaling associated with data reception or write operations), or clock signal transmission by the data interface 330 (e.g., second clock signaling associated with the data interface 330, RDQS_t/c signaling to the interface block 220-b, clock signaling associated with data transmission or read operations), or both. Each data interface 330 may transmit clock signaling (e.g., received clock signaling, DQS_t/c signaling) to sync/seq logic 360 via a respective bus (e.g., for timing of other operations of the interface block 245-b).

The interface controller 320 may support various control or configuration functionality of the interface block 245-b for accessing or otherwise managing operations of the coupled memory arrays 250. For example, the interface controller 320 may support access command coordination or configuration, latency or timing compensation, access command buffering (e.g., in accordance with a FIFO or other organizational scheme), mode registers or logic for configuration settings, or test functionality, among other functions or combinations thereof. For each data path of the interface block 245 (e.g., associated with a respective data interface 330), the interface controller 320 may be configured to transmit signaling to the respective memory arrays 250 via a bus 321 (e.g., address signaling, such as a row address or row activation signaling). For each data path of the interface block 245, the interface controller 320 may communicate signaling (e.g., timing signaling, which may be based on clock signaling received from the control interface 310, configuration signaling) with respective timing circuitries 370 and sync/seq logic 360 via respective buses.

For each data path, the respective timing circuitry 370 may support timing of various operations (e.g., activations, coupling operations, signal latching, signal driving) relative to timing signaling received from the interface controller 320. For example, timing circuitry 370 may include a timing chain (e.g., a global column timing chain) configured to generate one or more clock signals or other initiation signals for controlling operations of the respective data path, and such signaling may include transitions (e.g., rising edge transitions, falling edge transitions, on/off transitions) that are offset from, at a different rate from, or otherwise different from transitions of signaling from the interface controller 320 to support a given operation or combination of operations. For example, timing circuitry 370 may be configured to transmit signaling (e.g., column selection signaling, column address signaling) to the respective memory arrays 250, to transmit signaling to the respective write/sense circuitry 350 (e.g., latch or driver timing signaling), and to transmit signaling to the respective sync/seq logic (e.g., timing signaling).

For each data path, the respective FIFO/SERDES 340 may be configured to convert between data signaling of a first bus width (e.g., a relatively wide bus width, a data read/write (DRW) bus, a bus for communications with write/sense circuitry 350 having a relatively larger quantity of signal paths) and a second bus width (e.g., a relatively narrow bus width, a bus for communications with a data interface 330 having a relatively smaller quantity of signal paths). In some examples, such a conversion may be accompanied by changing a rate of signaling between signaling from the data interface 330 and the write/sense circuitry 350 (e.g., to maintain a given throughput). In various examples, the FIFO/SERDES 340 may receive data signaling from the data interface 330 and transmit data signaling to the write/sense circuitry 350 (e.g., to support a write operation), or may receive data signaling from the sense circuitry 350 and transmit data signaling to the data interface 330 (e.g., to support a read operation). In some examples (e.g., to support a read operation), the FIFO/SERDES 340 may be configured to transmit clock signaling (e.g., RDQS_t/c signaling) to the data interface 330, which may be forwarded to the interface block 220-b.

The timing or other synchronization of operations performed by the FIFO/SERDES 340 may be supported by one or more clock signals, among other signaling, received from the respective sync/seq logic 360. For example, the sync/seq logic 360 may generate or otherwise coordinate clock signaling to support the different rates of signaling of different buses (e.g., based on received clock signaling). Additionally, or alternatively, the FIFO/SERDES 340 may operate in a direction (e.g., for data transmission to a data interface 330, for data reception from a data interface 330) or other mode based on configuration signaling received from the sync/seq logic 360.

For each data path, the respective write/sense circuitry 350 may be configured to support the accessing (e.g., data signaling, write signaling, read signaling) of the respective set of one or more memory arrays 250. For example, the write/sense circuitry 350 may be coupled with the memory arrays 250 via a bus (e.g., a global input/output (GIO) bus), which may include respective signal paths associated with each memory array 250, or may include signal paths that are shared for all of the memory arrays 250 of the set, in which case the memory array circuitry may include multiplexing circuitry operable to couple the bus with a selected one of the memory arrays 250. In some examples, a bus between the write/sense circuitry and the set of one or more memory arrays 250 may include a same quantity of signal paths as a bus between the write/sense circuitry 350 and the FIFO/SERDES 340 (e.g., for signaling GIO [287:0]) or a same quantity of signal paths as a quantity of columns in each memory array 250. In some other examples, the memory arrays 250 may include a quantity of columns that is an integer multiple of the quantity of signal paths of the bus, in which case the memory array circuitry (e.g., each memory array 250) may include decoding circuitry operable to couple a subset of columns of memory cells, or associated circuitry, with the bus.

To support write operations, the write/sense circuitry 350 may be configured to drive signaling that is operable to write one or more logic states to memory cells of the memory arrays 250 (e.g., based on received data, based on received timing signaling, based on data signaling received via a bus 303 and on control signaling received via a bus 301-a). In some examples, such signaling may be transmitted to supporting circuitry of or otherwise associated with the memory arrays 250 (e.g., as an output of signals corresponding to logic states to be written), such as sense amplifier circuitry, voltage sources, current sources, or other driver circuitry operable to apply a bias across a storage element of the memory cells (e.g., across a capacitor, across a ferroelectric capacitor), or apply a charge, a current, or other signaling to a storage element of the memory cells (e.g., to apply a current to a chalcogenide or other configurable memory material, to apply a charge to a gate of a NAND memory cell), among other examples.

To support read operations, the write/sense circuitry 350 may be configured to receive signaling that the write/sense circuitry 350 may further amplify for communication through the interface block 245-b. For example, the write/sense circuitry 350 may be configured to receive signaling corresponding to logic states read from the memory arrays 250, but at a relatively low driver strength (e.g., relatively ‘analog’ signaling, which may be associated with a relatively low drive strength of sense amplifiers of the memory arrays 250). The write/sense circuitry 350 may thus include further sense amplification (e.g., a data sense amplifier (DSA) between signal paths between the write/sense circuitry and the set of one or more memory arrays and respective signal paths between the write/sense circuitry and the FIFO/SERDES), which each may have a relatively high drive strength (e.g., for driving relatively ‘digital’ signaling).

The features of the interface architecture 300 may be duplicated in various quantities and arrangements to support a semiconductor system having multiple dies, such as various examples of a system 200. In an example implementation, each die 240 may be configured with 64 instances of the interface block 245-b, which may support a data signaling width of 9,216 signal paths for each die 240 (e.g., where each bus 303 of a channel pair is associated with 72 signal paths). For a system 200 having a stack of eight dies 240 coupled with a die 205, the die 205 may thus be configured with 512 instances of the interface block 220-b, thereby supporting an overall data signaling width of 73,738 signal paths for the system 200. However, in other implementations, dies 205 and dies 240 may be configured with different quantities of interface blocks 220 and 245, respectively, and a system 200 may be configured with different quantities of dies 240 per die 205.

In some examples, a memory array 250 may be organized with rows of memory cells, each row associated with an address of the memory array 250. Each memory array 250 may be associated with (e.g., coupled with, include) a set of counters 380-a (e.g., located in a die 240). A set of counters 380-a may track access operations associated with the memory array 250 and may include a respective counter 380-a for each row of the memory array 250. For example, each counter 380-a may track a respective quantity of access operations on (e.g., activations of) a respective row of the memory array 250. In some examples, the interface controller 320 may operate (e.g., read, increment, write, reset) the counters 380-a via the bus 321. Additionally, or alternatively, the interface controller 320 may operate the counters 380-a via a dedicated bus 322 (e.g., a dedicated GIO bus, dedicated access lines). The interface controller 320 may detect row hammer attacks on the memory arrays 250 by monitoring quantities of access operations on the memory arrays 250 via the counters 380-a. For example, the interface controller 320 may compare a value of a counter 380-a to one or more threshold values to determine whether a row associated with the counters 380-a may be under row hammer attack based on whether the value satisfies at least one of the one or more threshold values.

Based on comparing respective values of the counters 380-a with one or more threshold values, the interface block 245-b may transmit alert signaling to the interface block 220-b (e.g., via one or more signal paths of the bus 301, via one or more alert pins of the bus 301) to perform row hammer mitigation operations, for example, if a value of a counter 380-a satisfies at least one of the one or more threshold values. The interface block 220 may evaluate the received alert signaling and may transmit refresh signaling including one or more refresh commands (e.g., via the bus 301) to the interface block 245-b in response to the alert signaling. A refresh command may indicate for the interface block 245-b (e.g., the interface controller 320) to refresh one or more rows (e.g., victim rows) of the memory array 250 that are neighboring to a row associated with the alert signaling (e.g., an aggressor row), which may mitigate adverse effects of the row hammer attack. However, in some cases, there may be errors associated with one or more counters 380-a, which may inhibit the interface block 245-b from accurately detecting row hammer attacks on the memory arrays 250 and thereby reduce reliability for row hammer mitigation.

In accordance with techniques described herein, a set of one or more counters 385-a (e.g., spare counters) may be implemented at the interface block 220-b to support increased reliability of row hammer mitigation operations. For example, the interface block 245-b may identify an error associated with a counter 380-a (e.g., or multiple counters 380-a) that tracks access operations on (e.g., activations of) a row of the memory array 250. The interface block 245-b may transmit alert signaling to the interface block 220-b to indicate the error and, in some examples, may refresh (e.g., reset) the counter 380-a. In response to the alert signaling indicating the error, the interface block 220-b may activate a counter 385-a of the interface block 220-b to track the access operations on the row (e.g., instead of or in addition to a counter 380-a). The interface block 220-b may then use the counter 385-a to evaluate whether to transmit refresh signaling for one or more neighboring (e.g., adjacent) rows adjacent of the row based on a value of the counter 385-a. Such implementation of counters 385-a at the interface block 220-b may increase reliability for row hammer mitigation operations by enabling a system (e.g., a TCDRAM system) to compensate for (e.g., tolerate, recover from) errors associated with the counters 380-a.

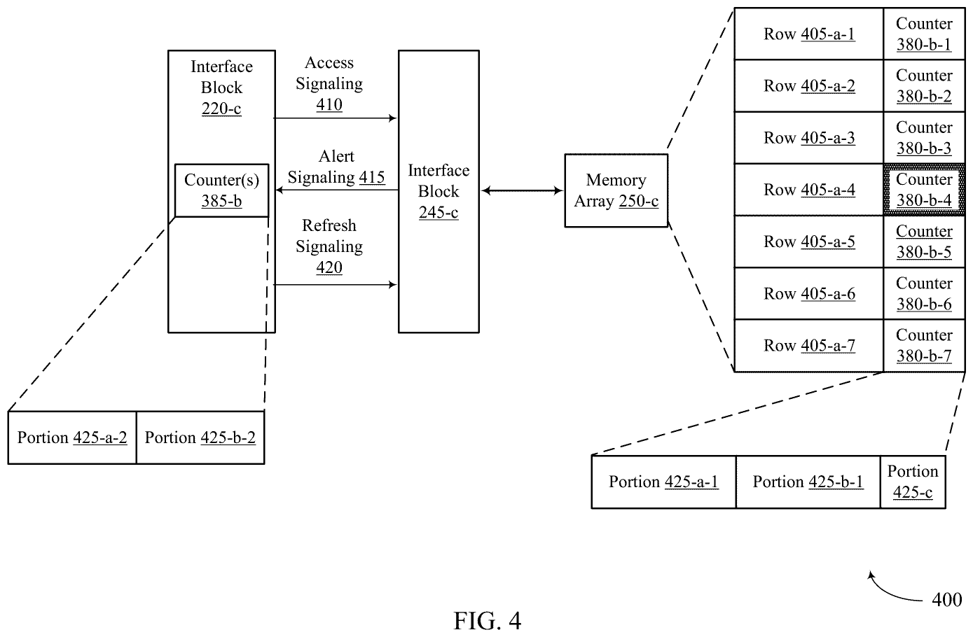

FIG. 4 shows an example of a system 400 that supports row hammer mitigation reliability in stacked memory architectures in accordance with examples as disclosed herein. The system 400 illustrates an example of an interface block 245-c (e.g., of a die 240) coupled with an interface block 220-c (e.g., of a die 205). The interface block 245-c and the interface block 220-c may include circuitry operable to perform the operations described herein. The interface block 245-c may be communicatively coupled with the interface block 220-c (e.g., via one or more of a bus 301, a bus 302, a bus 303, or a bus 304). The interface block 245-c may be coupled with one or more memory arrays 250, including a memory array 250-c. The one or more memory arrays 250 may each include multiple rows 405-a (e.g., rows 405-a-1 through 405-a-7), and each row 405-a may include a set of memory cells and be associated with a respective address (e.g., a physical address).

Each row 405 of the one or more memory arrays 250 may be associated with a respective counter 380-b (e.g., counters 380-b-1 through a counter 380-b-7, corresponding to rows 405-a-1 through 405-a-7). In some examples, the counters 380-b may be included in the memory array 250-c or may be located elsewhere in the die 240. The interface block 220-c may also include one or more counters 385-b (e.g., spare counters). In some examples, the one or more counters 385-b may be included in memory (e.g., SRAM, latches) of the interface block 220-c that may be allocated and deallocated for a counter 385-b. In some examples, the system 400 may use the one or more counters 385-b based on an error occurring with one of the counters 380-b. By including the one or more counters 385-b, the system 400 may increase reliability and efficiency associated with row hammer mitigation procedures.

In some cases, the system 400 may be subject to row hammer attacks, where a large quantity of access commands (e.g., via an interface block 220-c, within a relatively small amount of time) are issued to a row 405 of a memory array 250, which may be referred to as an aggressor row 405. Due to the successive access commands, electrical charge from the aggressor row 405 may leak to or from one or more memory cells of other rows 405 nearby the aggressor row 405 (e.g., neighboring rows 405 not associated with an address in the access command), which may be referred to as victim rows 405. An electrical charge leakage or other associated disturbance may affect the state (e.g., the electrical charge) of the memory cells in the victim rows, which may lead to modification of data stored in the memory cells of the victim rows. Thus, the system 400 may perform row hammer mitigations procedures to reduce (e.g., avoid) such adverse effects, which may include refreshing the state (e.g., logic state, electrical state) of the memory cells of the victim rows (e.g., to restore their correct state).

In some examples, the interface block 220-c may transmit access signaling 410 (e.g., an activate (ACT) command) to the interface block 245-c via a bus (e.g., a bus 301) to activate a first row 405-a (e.g., row 405-a-4) of the memory array 250-c. Based on receiving the access signaling 410, the interface block 245-c may activate (e.g., access) the first row 405-a of the multiple rows 405-a of the memory array 250-c. Each counter 380-b may be used (e.g., maintained, incremented) to track (e.g., count) a respective quantity of activations of (e.g., a respective quantity of access operations on) a corresponding row 405-a. For example, the counters 380-b may be implemented as per-row counters to count respective quantities of activations of each row 405-a. For example, the counter 380-b-1 may be used to track a quantity of activations of the row 405-a-1, the counter 380-b-2 may be used to track a quantity of activations of the row 405-a-2, and so on. Accordingly, based on accessing (e.g., activating) the first row 405-a, the interface block 245-c may increment a first counter 380-b associated with the first row 405-a (e.g., counter 380-b-4) to track a quantity of activations of the first row 405-a.

The counters 380-b may be used to support row hammer mitigation. For example, the interface block 245-c may transmit alert signaling 415 to the interface block 220-c (e.g., via the bus 301) based on determining that a value of a first counter 380-b satisfies one or more threshold values. In some examples, the counters 380-b may be multi-bit (e.g., 14 bit) counters with different subsets of bits of the counters 380-b being used to determine whether a value of a counter 380-b satisfies the one or more threshold values or to identify an error associated with the counter 380-b. Each counter 380-b may include multiple portions 425 (e.g., a portion 425-a-1 and a portion 425-b-1) that correspond to respective subsets of one or more bits of the counter 380-b. The interface block 245-c may use the portions 425 to determine whether a value of a counter 380-b satisfies the one or more threshold values or to identify an error associated with the counter 380-b. For example, each counter 380-b may include a portion 425-a-1 (e.g., a row hammer 1 (RH1) counter) to track a quantity of activations of (e.g., access operations on) a corresponding row 405-a, which may indicate whether the value of the counter 380-b satisfies a first threshold value.

Each counter 380-b may also include a portion 425-b-1 (e.g., a row hammer 2 (RH2) counter) that may track a quantity of occurrences that the counter 380-b (e.g., the portion 425-a-1) satisfies the first threshold value. For example, the interface block 245-c may increment the portion 425-b-1 based on the value of the counter 380-b satisfying the first threshold value, such as incrementing the portion 425-b-1 each time the portion 425-a-1 satisfies the first threshold value (e.g., each time the portion 425-a-1 is reset). The portion 425-b-1 may indicate whether the value of the counter 380-b satisfies a second threshold value. In some examples, the second threshold value may be greater than the first threshold value (e.g., may be a multiple of the first threshold value), for example, based on the RH2 counter being incremented in response to the first threshold value being satisfied.

The interface block 245-c may generate the alert signaling 415 according to various alert types based on comparing a value of the counter 380-b to the one or more threshold values or identifying an error with the counter 380-b. A first alert type (e.g., RH1 alert, RHALERT1) may be associated with the value of the counter 380-b (e.g., in the portion 425-a-1) satisfying the first threshold value. A second alert type (e.g., RH2 alert, RHALERT2) may be associated with the value of the counter 380-b (e.g., in the portion 425-b-1) satisfying the second threshold value. A third alert type may be associated with the value of the counter 380-b failing to satisfy the one or more threshold values (e.g., the first threshold value and the second threshold value) and that no error is identified for the counter 380-b. In some examples, if the value of the counter 380-b fails to satisfy the one or more thresholds, the interface block 245-c may refrain from generating alert signaling 415 according to the third alert type (e.g., no alert). For example, the third alert type may correspond to no alert being sent.

Based on receiving the alert signaling 415 indicating that one or more of the threshold values are satisfied, the interface block 220-c may transmit refresh signaling 420 (e.g., via the bus 301) to the interface block 245-c that instructs (e.g., causes, commands) the interface block 245-c to refresh one or more rows 405-a of the memory array 250-c that are neighboring (e.g., adjacent) to the first row 405-a. The refresh signaling 420 may include one or more refresh commands for one or more rows 405-a based on the alert type. In some examples, if the alert type is a first alert type (e.g., RHIALERT), the refresh signaling 420 may include one or more refresh commands to refresh one or more rows 405-a that are near (e.g., directly adjacent to, neighboring) the first row 405-a (e.g., the aggressor row) associated with the alert signaling 415. For example, if the alert signaling 415 indicates the first alert type and is associated with row 405-a-4, the interface block 220-c may issue one or more (e.g., respective) refresh commands for row 405-a-3 and row 405-a-5 that are directly adjacent to the row 405-a-4. If the alert type indicates a second alert type (e.g., RH2ALERT), the refresh signaling 420 may include one or more sets of refresh commands for one or more rows 405-a that are not directly adjacent to the first row 405-a in addition to the directly adjacent rows 405-a. For example, the interface block 220-c may issue one or more (e.g., respective) refresh commands for row 405-a-2 and row 405-a-6, in addition to one or more refresh commands for row 405-a-3 and row 405-a-5.

Such refresh operations may mitigate undesired effects (e.g., data modification) of a row hammer attack or other adverse accessing. However, in some cases, the counters 380-b may experience errors, which may corrupt values stored at the counters 380-b. As such, the interface block 245-c may be unable to accurately identify row hammer attacks or may falsely identify row hammer attacks. For example, a counter 380-b may have a permanent error that includes one or more bits of the counter 380-b being permanently stuck at a ‘1’ or ‘0’), which may cause inaccuracies associated with whether a value of the counter 380-b satisfies the one or more threshold values. For example, depending on the which bits are stuck and to which state the bits are stuck, such permanent errors may cause a value of the counter 380-b to satisfy a threshold more frequently than desired (e.g., for each issued ACT command) or to satisfy a threshold less frequently than desired (e.g., not satisfying a threshold regardless of the quantity of ACT commands issued). Additionally, or alternatively, a counter 380-b may experience a transient error (e.g., a temporary error), in which one or more bits of the counter 380-b temporarily change to an incorrect state, but for which the error is not permanent. Such transient errors may cause an interface block 245-c to inadvertently issue or fail to issue alert signaling 415 to the interface block 220-c. Thus, techniques that compensate for errors associated with the counters 380-b may increase system reliability, for example, by supporting a more-reliable issuing of refresh signaling 420 to protect against row hammer attacks, and increase system efficiency, for example, by reducing unnecessary performance of refresh operations.

In accordance with techniques described herein, the interface block 245-c may identify an error associated with a counters 380-b and may transmit alert signaling 415 including an indication of the error associated with the counter 380-b to the interface block 220-c. For example, the counter 380-b may also include a portion 425-c (e.g., one or more parity bits, a cyclic redundancy check (CRC) portion, an error correction code (ECC) portion) that the interface block 245-c may use to identify an error associated with the counter 380-b. For instance, the interface block 245-c may identify (e.g., detect) an error associated with a counter 380-b using the one or more parity bits or error correction bits of the counter 380-b, performing a CRC operation based on reading the portion 425-c, or a combination thereof. A fourth alert type (e.g., a counter error alert, RHALERTERR) may be associated with the interface block 245-c identifying an error (e.g., a permanent error, a transient error) with the counter 380-b (e.g., indicated by the portion 425-c), and the interface block 245-c may transmit the alert signaling 415 indicating the fourth alert type based on identifying the error. In some examples, the interface block 245-c may reset a counter 380-b in response to identifying the error or transmitting the alert signaling 415, such as by resetting the portions 425-a-1 and 425-b-1 (e.g., and the portion 425-c).

In response to receiving alert signaling 415 that includes an indication of an error associated with a counter 380-b (e.g., corresponding to a first row 405-a), the interface block 220-c may activate (e.g., add, allocate) a counter 385-b (e.g., a spare counter), which may be associated with (e.g., mapped to) the row of the one or more memory arrays 250-c that experienced an error with the counter 380-b. The counter 385-b may be located in memory of the interface block 220-c, such as volatile memory (e.g., SRAM), latches, content addressable memory (CAM), or a combination thereof. Additionally, or alternatively, the counter 385-b may be located in memory of a die 205 that is accessible by the interface block 220-c. Because an error may corrupt the information stored in the counter 380-b, it may be unknown whether a value of the counter 380-b satisfies one or more threshold values (e.g., a first threshold value or a second threshold value). Accordingly, in some examples, the interface block 220-c may transmit refresh signaling 420 to refresh one or more rows 405-a adjacent to the first row 405-a based on receiving the alert signaling 415. For instance, the refresh signaling 420 may include one or more sets of refresh commands for one or more rows 405-a that are non-directly adjacent to the first row 405-a in addition to the directly adjacent rows 405-a, for example, as if the alert signaling 415 indicated the second alert type. For example, if the interface block 220-c receives an indication of an error associated with a counter 380-b-4 corresponding to row 405-a-4, the interface block 220-c may issue refresh commands for row 405-a-2, row 405-a-3, row 405-a-5, and row 405-a-6.

The interface block 220-c may use the counter 385-b (e.g., instead of or in addition to the counter 380-b) to track a quantity of access operations for the first row 405-a and may transmit refresh signaling to the interface block 245-c based on a value of the counter 385-b (e.g., based on comparing the value to one or more threshold values). For example, the counter 385-b may include a portion 425-a-2 that the interface block 220-c may use to determine whether the value of the counter 385-b satisfies a first threshold value. If the value of the counter 385-b satisfies the first threshold value, the interface block 220-c may transmit refresh signaling 420, for example, as if the interface block 220-c received alert signaling 415 indicating the first alert type. For example, the interface block 220-c may include a first quantity of refresh commands in the refresh signaling 420, such as to refresh rows 405-a adjacent to the first row 405-a. Additionally the counter 385-b may include a portion 425-b-2 that the interface block 220-c may use to determine whether the value of the counter 385-b satisfies a second threshold value (e.g., greater than the first threshold value). If the value of the counter 385-b satisfies the second threshold value, the interface block 220-c may transmit refresh signaling 420, for example, as if the interface block 220-c received alert signaling 415 indicating the second alert type. For example, the interface block 220-c may include a second quantity of refresh commands greater than the first quantity in the refresh signaling 420, such as to refresh both adjacent and non-directly adjacent rows 405-a. In some examples, the counter 385-b may include a portion 425-c, for example, to support identification of errors associated with the counter 385-b.

The counter 385-b may allow the interface block 220-c to transmit refresh signaling 420 independent of the counter 380-b. For instance, the interface block 220-c may transmit refresh signaling based on a value of the counter 385-b satisfying a threshold value (e.g., for row hammer mitigation) while a value of the counter 380-b fails to satisfy the threshold value, such as due to an error (e.g., an ongoing error, a previous error). In some examples, the interface block 220-c may deactivate (e.g., deallocate, remove) a relatively unused counter 385-b (e.g., a counter 385-b for which a value of the counter 385-b fails to satisfy a threshold value within a duration) for example, to support reallocating memory for the counter 385-b for other uses. For instance, the counter 385-b may be activated, but the row 405-a associated with the counter 385-b may not undergo enough access operations to cause the value of the counter 385-b to satisfy the threshold value within a duration. As such, the interface block 220-c may deactivate the counter 385-b, and the system 400 may revert to using a counter 380-b to detect row hammer attacks.

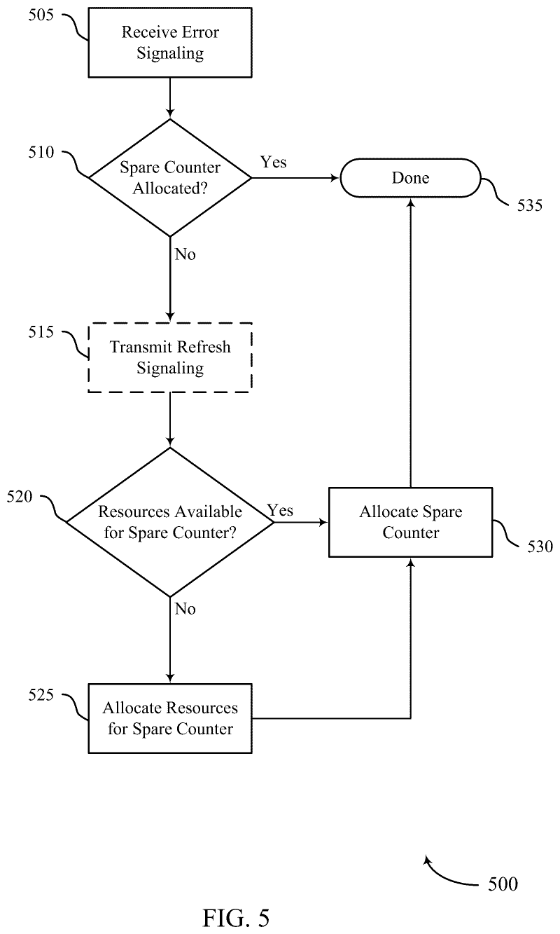

FIG. 5 shows an example of a process 500 that supports row hammer mitigation reliability in stacked memory architectures in accordance with examples as disclosed herein. In some examples, the process 500 may be implemented by components of a system 100, a system 200, an interface architecture 300, or a system 400. For example, one or more aspects of the process 500 may be implemented by an interface block 220 (e.g., of a die 205). The process 500 may be an example of allocating a spare counter (e.g., a counter 385) in a system, which the system may use for increased reliability in row hammer mitigation procedures.

At 505, the process 500 may include receiving error signaling (e.g., from an interface block 245). The error signaling (e.g., alert signaling 415) may be in response to access signaling (e.g., an ACT command) transmitted by the interface block 220. The error signaling may include an indication to the interface block 220 of an error associated with a counter (e.g., a counter 380) that tracks a quantity of access operations on (e.g., activations of) a row (e.g., an address) of a memory array (e.g., a memory array 250 of a die 240). For example, the error signaling may be associated with a particular row of a memory array whose corresponding counter in the memory has an error. In some examples, the timing of the error signaling may be deterministic such that the interface block 220 may determine that the error signaling corresponds to the row and the counter. For example, error signaling may be transmitted to the interface block 220 a deterministic duration (e.g., quantity of clock cycles, such as 13 command clock cycles) after access signaling is transmitted by the interface block 220. Accordingly, the interface block 220 may determine the row for which the error signaling is indicating an error of the associated counter due to having issued the access signaling for the row, for example, the quantity of clock cycles prior to receiving the error signaling.

At 510, the process 500 may include determining whether a spare counter is allocated (e.g., at the interface block 220) for tracking access operations on the row. In some examples, if a spare counter is allocated for the row, the process 500 may proceed to 535 and conclude. For example, a spare counter may already be allocated (e.g., may have been previously allocated) for the row and no further action is to be taken. Alternatively, if a spare counter for the row is not allocated, the process may proceed to 515.

At 515, in some examples, the process 500 may include transmitting refresh signaling (e.g., from the interface block 220 to an interface block 245) based on receiving the error signaling. Because the error signaling indicates an error associated with the counter of the row, it may be indeterminate whether a true value of the counter indicates that row hammer mitigation is to be performed for one or more second rows neighboring (e.g., adjacent to) the first row. As such, in some examples, the interface block 220 may transmit refresh signaling (e.g., to the interface block 245) to refresh the one or more second rows adjacent to the first row (e.g., as a precaution). In some examples, the one or more second rows may include at least four rows adjacent to the row. For example, the one or more second rows may include second rows that are adjacent to the row on either side of the row and rows that are non-directly adjacent to the row itself, but that are adjacent to adjacent rows (e.g., the one or more second rows may include the two physically closest rows to the row on each side of the row, or some other quantity of rows on each side of the row).

At 520, the process 500 may include determining whether resources (e.g., space in memory) are available to allocate (e.g., activate) a spare counter (e.g., at the interface block 220). If sufficient resources are available to allocate the spare counter, the process 500 may proceed to 530. If there are not sufficient resources available for the spare counter, the process 500 may proceed to 525.

At 525, the process 500 may include allocating resources (e.g., a content addressable memory (CAM) entry, a portion of a volatile memory, one or more latches) to use for a spare counter. In some examples, a quantity of resources for spare counters at an interface block 220 (e.g., or a die 205 that includes the interface block 220) may be limited (e.g., less than a second quantity of resources for counters at an interface block 245). As such, in order to allocate sufficient resources for the spare counter, the interface block 220 may remove (e.g., deallocate, reallocate) other resources (e.g., other spare counters, other CAM entries) from the quantity of resources. The interface block 220 may determine which entry (e.g., or entries) to remove based on a policy (e.g., a least recently used (LRU) policy), where the entry that is least recently used is removed to free resources for the spare counter. Other policies for selecting resources to reallocate for the spare counter may be implemented.

At 530, the process 500 may include allocating a spare counter to track (e.g., count) access activations of the row. For example, the interface block 220 may allocate (e.g., activate) a portion of a memory array (e.g., of a die 205) for the spare counter. Resources for the spare counter may be the allocated resources from 525. In some examples, the interface block 220 may associate the spare counter with an address (e.g., a row) of one or more memory arrays (e.g., of a die 240) that is associated with a counter (e.g., an errored counter). For example, the interface block 220 may associate the spare counter with the row for which the error signaling indicated the error for the associated counter. In some examples, to associate the spare counter with the row, the interface block 220 may store an address of the row, for example, indicating a pseudo channel used to access the row, a bank that includes the row, and a row address of the row. The interface block 220 may associate the spare counter with the stored address. In some examples, the portion of the memory array may be operable as a CAM, volatile memory (e.g., SRAM), latches, or some other type of memory. In some examples, if the portion of the memory array is operable as a CAM, the interface block 220 may activate the spare counter by adding an entry to the CAM, for example, that is identified by the address of the row and whose content is the value of the spare counter. After allocating the spare counter, the process may proceed to 535 and conclude.

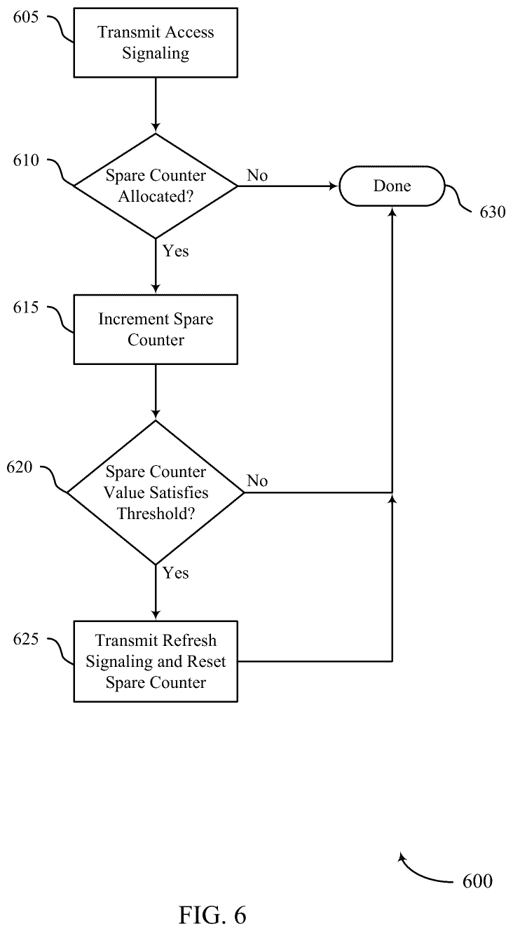

FIG. 6 shows an example of a process 600 that supports row hammer mitigation reliability in stacked memory architectures in accordance with examples as disclosed herein. In some examples, the process 600 may be implemented by components of a system 100, a system 200, an interface architecture 300, or a system 400. For example, one or more aspects of the process 600 may be implemented by an interface block 220 (e.g., of a die 205). The process 600 may be an example of adjusting (e.g., manipulating, incrementing, resetting) a spare counter (e.g., a counter 385, a CAM entry) in a system, which may enable improved reliability in row hammer mitigation procedures.

At 605, the process 600 may include transmitting access signaling (e.g., from the interface block 220 to an interface block 245). The access signaling may include a command (e.g., an ACT command) to activate a row of a memory array (e.g., of a die 240).

At 610, based on transmitting the access signaling, the process 600 may include determining whether a spare counter for the row is allocated (e.g., in CAM of the interface block 220, in the die 205). If a spare counter is not allocated for the row, the process may proceed to 630 and conclude. If a spare counter is allocated for the row, the process 600 may proceed to 615.

At 615, the process 600 may include incrementing a value of the spare counter based on transmitting the access signaling at 605. For example, the spare counter may be used to count a quantity of activations of the row indicated by the access signaling, and the interface block 220 may increment the value of the spare counter to count the activation of the row resulting from the transmission of the access signaling.

At 620, the process 600 may include reading the value of the spare counter and determining whether the value satisfies one or more threshold values (e.g., for row hammer mitigation). For example, the interface block 220 may compare the value to a first threshold value, a second threshold value (e.g., greater than the first threshold value), or both and determine whether the value satisfies the first threshold value, the second threshold value, or both. If the value of the spare counter fails to satisfy the one or more threshold values, the process 600 may proceed to 630 and conclude. If the value of the spare counter satisfies at least one threshold value of the one or more threshold values, the process 600 may proceed to 625.

At 625, the process 600 may include transmitting refresh signaling (e.g., by the interface block 220 to the interface block 245) and resetting one or more portions (e.g., or all portions) of the spare counter based on the value of the spare counter satisfying one or more thresholds. For example, the value of the counter may satisfy the first threshold value. Accordingly, the interface block 220 may transmit refresh signaling that includes refresh commands for a first quantity of rows (e.g., two rows) near the row associated with the access signaling (e.g., two rows adjacent to the row, one row on either side) and reset a first portion (e.g., a portion 425-a) of the spare counter. Additionally, or alternatively, the value of the counter may satisfy the second threshold value. Accordingly, the interface block 220 may transmit refresh signaling that includes refresh commands for a second quantity of rows (e.g., four rows) near the row associated with the access signaling (e.g., four rows adjacent to the row, two rows on either side) and may reset at least a second portion (e.g., a portion 425-b) of the spare counter. The process 600 may proceed to 630 and conclude.

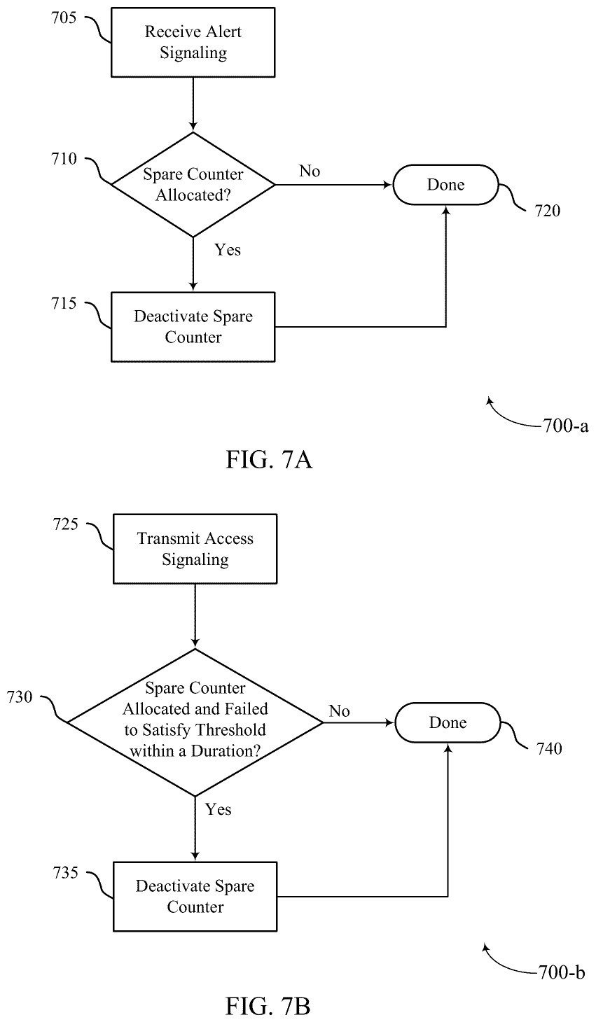

FIG. 7A shows an example of a process 700-a that supports row hammer mitigation reliability in stacked memory architectures in accordance with examples as disclosed herein. In some examples, the process 700-a may be implemented by components of a system 100, a system 200, an interface architecture 300, or a system 400. For example, one or more aspects of the process 700-a may be implemented by an interface block 220 (e.g., of a die 205). The process 700-a may be an example of a first process for deactivating (e.g., deleting, deallocating, removing) a spare counter (e.g., a counter 385, a CAM entry) from a system.

At 705, the process 700-a may include receiving alert signaling (e.g., from an interface block 245, such as alert signaling 415). The alert signaling may indicate that a value of a counter (e.g., different from a spare counter, a counter at a memory array of a die 240), associated with a row of the memory array, satisfies a threshold value. In some examples, the interface block 220 may have (e.g., previously) received error signaling associated with the counter and allocated a spare counter for the row corresponding to the counter (e.g., as described with reference to FIG. 5). However, receiving the alert singling may indicate, to the interface block 220, that the counter is no longer associated with an error (e.g., the error may have been a transient error) and thus, the spare counter may be deactivated.

At 710, the process 700-a may include determining whether a spare counter is allocated for the row (e.g., in the CAM of the interface block 220, in the die 205). If a spare counter is not allocated for the row, the process 700-a may proceed to 720 and conclude. If a spare counter is allocated for the row, the process 700-a may proceed to 715.

At 715, the process 700-a may include deactivating the spare counter (e.g., based on receiving the alert signaling). In some examples, the spare counter may be associated with a portion of a memory at a die 205 and the interface block 220 may deallocate the portion for the spare counter. In some examples, the interface block 220 may further disassociate the spare counter with an address (e.g., a row) of one or more memory arrays (e.g., at a die 240) that is associated with a counter (e.g., at the die 240). In some examples, the interface block 220 may deallocate the portion and disassociate the spare counter with the address by deleting a CAM entry corresponding to the address and whose content is representative of a value of the spare counter.

FIG. 7B shows an example of a process 700-b that supports row hammer mitigation reliability in stacked memory architectures in accordance with examples as disclosed herein. In some examples, the process 700-b may be implemented by components of a system 100, a system 200, an interface architecture 300, or a system 400. For example, one or more aspects of the process 700-b may be implemented by an interface block 220 (e.g., of a die 205). The process 700-b may be an example of a second process for deactivating (e.g., deleting, deallocating, removing) a spare counter (e.g., a counter 385, a CAM entry) from a system.

At 725, the process 700-b may include transmitting access signaling (e.g., to an interface block 245). The access signaling may include a command (e.g., an ACT command) to activate a row of a memory array (e.g., of a die 240). Based on transmitting the access signaling, the interface block 220 may increment a value of a spare counter (e.g., as described with reference to FIG. 6).

At 730, the process 700-b may include determining whether the spare counter is allocated for the row (e.g., in the CAM of the interface block 220, in the die 205) and whether a value of the spare counter satisfies a threshold value within a duration. If either the spare counter is not allocated or the value of the spare counter satisfies (e.g., is greater than, greater than or equal to) a threshold value within the duration, the process 700-b may proceed to 740 and conclude. If the spare counter is allocated for the row and the value of the spare counter fails to satisfy the threshold value within the duration, the process 700-b may proceed to 735.

At 735, the process 700-b may include deactivating the spare counter (e.g., based on the value of the spare counter failing to satisfy the threshold value within the duration). For example, the value of the spare counter failing to satisfy the threshold value within the duration may indicate that the associated row is not being frequently accessed. Accordingly, the resources for the spare counter may be deallocated and used for other purposes. In some examples, the spare counter may be associated with a portion of a memory at a die 205 and the interface block 220 may deallocate the portion for the spare counter. In some examples, the interface block 220 may further disassociate the spare counter with an address (e.g., a row) of one or more memory arrays (e.g., at a die 240) that is associated with a counter (e.g., at the die 240). In some examples, the interface block 220 may deallocate the portion and disassociate the spare counter with the address by deleting a CAM entry corresponding to the address and whose content is representative of a value of the spare counter.

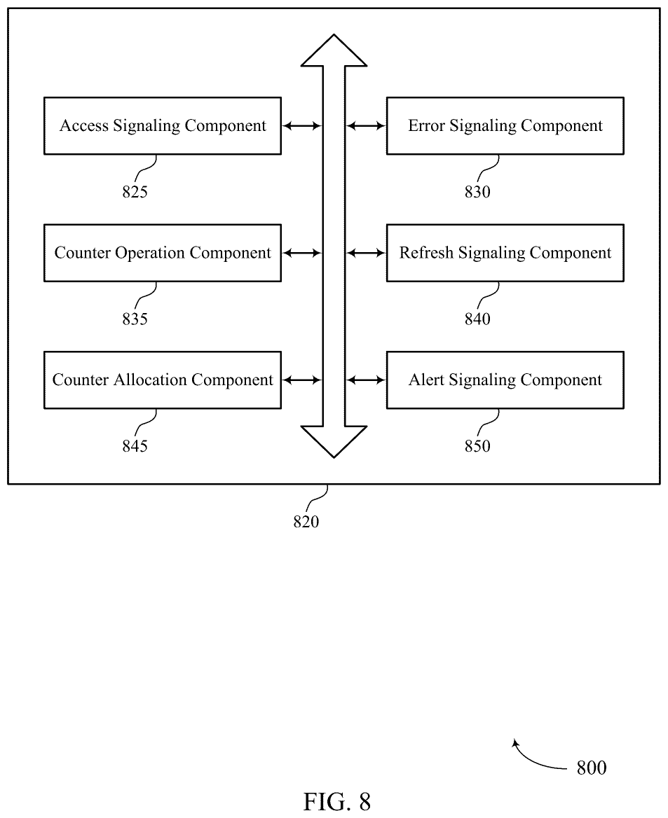

FIG. 8 shows a block diagram 800 of a logic die 820 (e.g., a die 205) that supports row hammer mitigation reliability in stacked memory architectures in accordance with examples as disclosed herein. The logic die 820 may be an example of aspects of a logic die as described with reference to FIGS. 1 through 7B. The logic die 820, or various components thereof (e.g., an interface block 220, circuitry of the interface block 220), may be an example of means for performing various aspects of row hammer mitigation reliability in stacked memory architectures as described herein. For example, the logic die 820 (e.g., an interface block 220) may include an access signaling component 825, an error signaling component 830, a counter operation component 835, a refresh signaling component 840, a counter allocation component 845, an alert signaling component 850, or any combination thereof. Each of these components, or components of subcomponents thereof (e.g., one or more processors, one or more memories), may communicate, directly or indirectly, with one another (e.g., via one or more buses).

The access signaling component 825 may be configured as or otherwise support a means for transmitting, from a first interface (e.g., an interface block 220) of a first semiconductor die (e.g., the logic die 820) to a second interface (e.g., an interface block 245) of a second semiconductor die (e.g., an array die, a die 240) coupled with the first semiconductor die, first signaling (e.g., one or more signals, one or more indications) including a first command to activate a row of a memory array of the second semiconductor die. The error signaling component 830 may be configured as or otherwise support a means for receiving, at the first interface from the second interface based on transmitting the first signaling, second signaling indicating an error associated with a first counter of the second semiconductor die for counting activations of the row of the memory array. The counter operation component 835 may be configured as or otherwise support a means for activating, at the first interface, a second counter of the first semiconductor die for counting activations of the row of the memory array based on receiving the second signaling indicating the error. The refresh signaling component 840 may be configured as or otherwise support a means for transmitting, from the first interface to the second interface based on the indication of the error or a value of the second counter, third signaling including a second command to refresh one or more rows of the memory array different from the row.

In some examples, to support activating the second counter, the counter allocation component 845 may be configured as or otherwise support a means for allocating a portion of a second memory array of the first semiconductor die for the second counter. In some examples, to support activating the second counter, the counter allocation component 845 may be configured as or otherwise support a means for associating the second counter with the row.

In some examples, the access signaling component 825 may be configured as or otherwise support a means for transmitting, from the first interface to the second interface after activating the second counter, fourth signaling including a third command to activate the row. In some examples, the counter operation component 835 may be configured as or otherwise support a means for incrementing, at the first interface, the value of the second counter based on transmitting the fourth signaling. In some examples, the refresh signaling component 840 may be configured as or otherwise support a means for transmitting the third signaling from the first interface to the second interface based on the value of the second counter satisfying one or more thresholds. In some examples, the counter operation component 835 may be configured as or otherwise support a means for resetting, at the first interface, one or more portions of the second counter based on transmitting the third signaling.

In some examples, the alert signaling component 850 may be configured as or otherwise support a means for receiving, at the first interface from the second interface after receiving the second signaling, fourth signaling indicating that a value of the first counter satisfies a threshold. In some examples, the counter operation component 835 may be configured as or otherwise support a means for deactivating, at the first interface, the second counter based on receiving the fourth signaling.

In some examples, the counter operation component 835 may be configured as or otherwise support a means for deactivating, at the first interface, the second counter based on the value of the second counter failing to satisfy a threshold within a duration.

In some examples, the first interface may include the second counter.

In some examples, to support transmitting the third signaling, the refresh signaling component 840 may be configured as or otherwise support a means for transmitting the third signaling in response to receiving the second signaling indicating the error, the one or more rows of the memory array different from the row comprising a first set of rows and a second set of rows different from the first set of rows based on the second signaling indicating the error.

In some examples, the described functionality of the logic die 820, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the logic die 820, or various components thereof, may be implemented at least in part by instructions (e.g., stored in memory, non-transitory computer-readable medium) executable by such at least one processor.

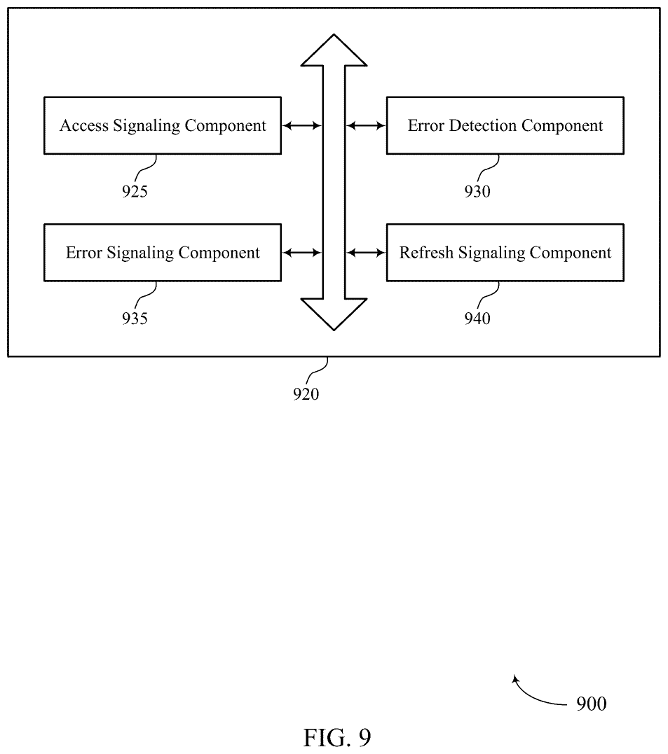

FIG. 9 shows a block diagram 900 of an array die 920 (e.g., a die 240) that supports row hammer mitigation reliability in stacked memory architectures in accordance with examples as disclosed herein. The array die 920 may be an example of aspects of an array die as described with reference to FIGS. 1 through 7. The array die 920, or various components thereof (e.g., an interface block 245, circuitry of the interface block 245), may be an example of means for performing various aspects of row hammer mitigation reliability in stacked memory architectures as described herein. For example, the array die 920 (e.g., the interface block 245) may include an access signaling component 925, an error detection component 930, an error signaling component 935, a refresh signaling component 940, or any combination thereof. Each of these components, or components of subcomponents thereof (e.g., one or more processors, one or more memories), may communicate, directly or indirectly, with one another (e.g., via one or more buses).

The access signaling component 925 may be configured as or otherwise support a means for receiving, from a first interface (e.g., an interface block 220) of a first semiconductor die (e.g., a logic die, a die 205) at a second interface (e.g., an interface block 245) of a second semiconductor die (e.g., the array die 920, a die 240), first signaling including a first command to activate a row of a memory array of the second semiconductor die. The error detection component 930 may be configured as or otherwise support a means for identifying, at the second interface based on the first signaling, an error associated with a counter of the second semiconductor die for counting activations of the row of the memory array. The error signaling component 935 may be configured as or otherwise support a means for transmitting, from the second interface to the first interface based on identifying the error, second signaling including an indication of the error. The refresh signaling component 940 may be configured as or otherwise support a means for receiving, from the first interface based on transmitting the second signaling, third signaling including a second command to refresh one or more second rows of the memory array different from the row.

In some examples, the error detection component 930 may be configured as or otherwise support a means for resetting a value of the counter based on transmitting the second signaling to the first interface.

In some examples, the refresh signaling component 940 may be configured as or otherwise support a means for receiving, based on transmitting the second signaling and after receiving the third signaling, fourth signaling including a third command to refresh the one or more second rows while a value of the counter fails to satisfy a threshold.

In some examples, to support identifying the error, the error detection component 930 may be configured as or otherwise support a means for identifying the error based on one or more parity bits of the counter, one or more error detection bits of the counter, a CRC operation based on an indication of the counter, or any combination thereof.

In some examples, the described functionality of the array die 920, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the array die 920, or various components thereof, may be implemented at least in part by instructions (e.g., stored in memory, non-transitory computer-readable medium) executable by such at least one processor.

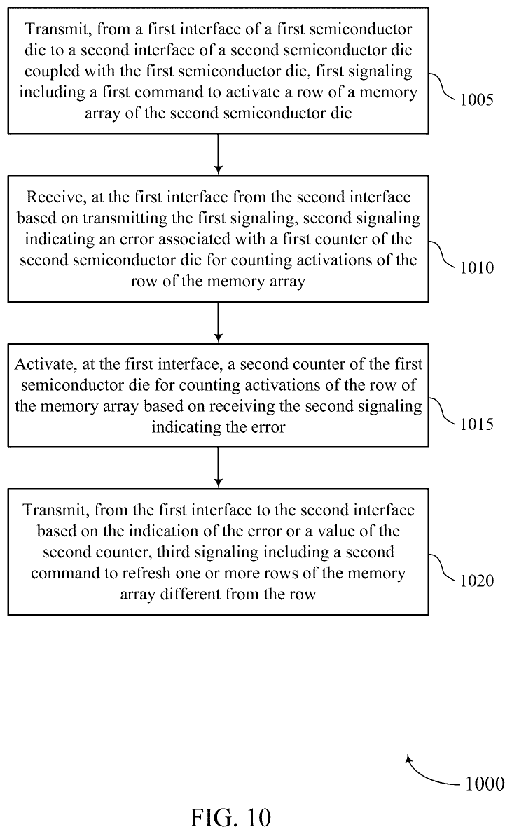

FIG. 10 shows a flowchart illustrating a method 1000 that supports row hammer mitigation reliability in stacked memory architectures in accordance with examples as disclosed herein. The operations of method 1000 may be implemented by a logic die (e.g., a die 205) or its components as described herein (e.g., an interface block 220). For example, the operations of method 1000 may be performed by a logic die as described with reference to FIGS. 1 through 8. In some examples, a logic die may execute a set of instructions to control the functional elements of the device to perform the described functions. Additionally, or alternatively, the logic die may perform aspects of the described functions using special-purpose hardware.

At 1005, the method may include transmitting, from a first interface of a first semiconductor die to a second interface of a second semiconductor die coupled with the first semiconductor die, first signaling including a first command to activate a row of a memory array of the second semiconductor die. For example, a die 205 may include an interface block 220 that transmits access signaling 410 (e.g., via a bus 301), including an ACT command, to an interface block 245 of a die 240. The access signaling 410 may instruct the interface block 245 to activate a row 405-a of a memory array 250 included in a die 240. In some examples, aspects of the operations of 1005 may be performed by an access signaling component 825 as described with reference to FIG. 8.

At 1010, the method may include receiving, at the first interface from the second interface based on transmitting the first signaling, second signaling indicating an error associated with a first counter of the second semiconductor die for counting activations of the row of the memory array. For example, an interface block 220 may receive alert signaling 415 (e.g., via a bus 301) from an interface block 245 based on transmitting access signaling. The alert signaling 415 may indicate an error associated with a counter 380 of a die 240, where the counter 380 counts activations of a row 405-a of a memory array 250 at the die 240. In some examples, aspects of the operations of 1010 may be performed by an error signaling component 830 as described with reference to FIG. 8.

At 1015, the method may include activating, at the first interface, a second counter of the first semiconductor die for counting activations of the row of the memory array based on receiving the second signaling indicating the error. For example, based on receiving error signaling from an interface block 245, an interface block 220 may activate (e.g., allocate) a counter 385 (e.g., a spare counter) at a die 205, where the spare counter counts activations of a row 405-a of a memory array 250 at the die 240. In some examples, aspects of the operations of 1015 may be performed by a counter operation component 835 as described with reference to FIG. 8.

At 1020, the method may include transmitting, from the first interface to the second interface based on the indication of the error or a value of the second counter, third signaling including a second command to refresh one or more rows of the memory array different from the row. For example, an interface block 220 may transmit refresh signaling 420 to an interface block 245 based on receiving error signaling from the interface block 245. The refresh signaling 420 may include refresh commands to refresh one or more rows 405-a of a memory array 250 different from a row 405-a associated with the error signaling. In some examples, aspects of the operations of 1020 may be performed by a refresh signaling component 840 as described with reference to FIG. 8.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transmitting, from a first interface of a first semiconductor die to a second interface of a second semiconductor die coupled with the first semiconductor die, first signaling including a first command to activate a row of a memory array of the second semiconductor die; receiving, at the first interface from the second interface based on transmitting the first signaling, second signaling indicating an error associated with a first counter of the second semiconductor die for counting activations of the row of the memory array; activating, at the first interface, a second counter of the first semiconductor die for counting activations of the row of the memory array based on receiving the second signaling indicating the error; and transmitting, from the first interface to the second interface based on the indication of the error or a value of the second counter, third signaling including a second command to refresh one or more rows of the memory array different from the row.

Aspect 2: The method, apparatus, or non-transitory computer-readable medium of aspect 1, where activating the second counter includes operations, features, circuitry, logic, means, or instructions, or any combination thereof for allocating a portion of a second memory array of the first semiconductor die for the second counter and associating the second counter with the row.

Aspect 3: The method, apparatus, or non-transitory computer-readable medium of any of aspects 1 through 2, further including operations, features, circuitry, logic, means, or instructions, or any combination thereof for transmitting, from the first interface to the second interface after activating the second counter, fourth signaling including a third command to activate the row; incrementing, at the first interface, the value of the second counter based on transmitting the fourth signaling; transmitting the third signaling from the first interface to the second interface based on the value of the second counter satisfying one or more thresholds; and resetting, at the first interface, one or more portions of the second counter based on transmitting the third signaling.

Aspect 4: The method, apparatus, or non-transitory computer-readable medium of any of aspects 1 through 3, further including operations, features, circuitry, logic, means, or instructions, or any combination thereof for receiving, at the first interface from the second interface after receiving the second signaling, fourth signaling indicating that a value of the first counter satisfies a threshold and deactivating, at the first interface, the second counter based on receiving the fourth signaling.

Aspect 5: The method, apparatus, or non-transitory computer-readable medium of any of aspects 1 through 4, further including operations, features, circuitry, logic, means, or instructions, or any combination thereof for deactivating, at the first interface, the second counter based on the value of the second counter failing to satisfy a threshold within a duration.

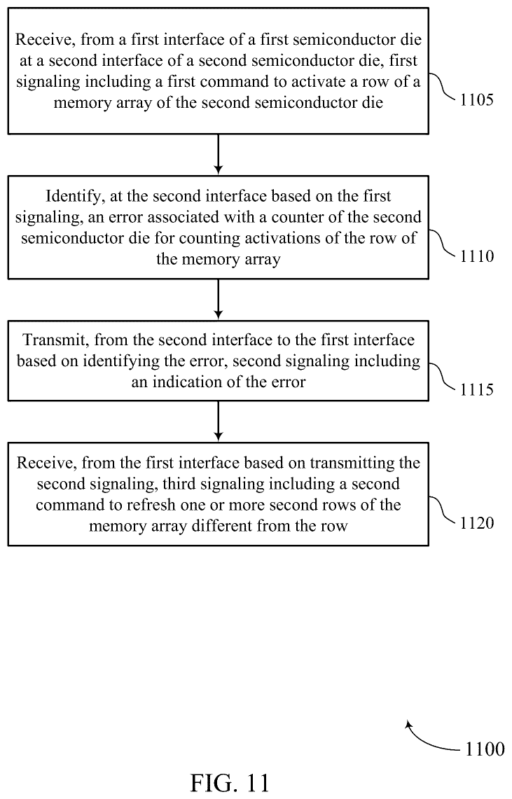

FIG. 11 shows a flowchart illustrating a method 1100 that supports row hammer mitigation reliability in stacked memory architectures in accordance with examples as disclosed herein. The operations of method 1100 may be implemented by an array die (e.g., a die 240) or its components (e.g., an interface block 245) as described herein. For example, the operations of method 1100 may be performed by an array die as described with reference to FIGS. 1 through 7 and 9. In some examples, an array die may execute a set of instructions to control the functional elements of the device to perform the described functions. Additionally, or alternatively, the array die may perform aspects of the described functions using special-purpose hardware.

At 1105, the method may include receiving, from a first interface of a first semiconductor die at a second interface of a second semiconductor die, first signaling including a first command to activate a row of a memory array of the second semiconductor die. For example, a die 240 may include an interface block 245 that receives access signaling 410 (e.g., via a bus 301), including an ACT command, from an interface block 220 of a die 205. The access signaling 410 may instruct the interface block 245 to activate a row 405-a of a memory array 250 included in a die 240. In some examples, aspects of the operations of 1105 may be performed by an access signaling component 925 as described with reference to FIG. 9.

At 1110, the method may include identifying, at the second interface based on the first signaling, an error associated with a counter of the second semiconductor die for counting activations of the row of the memory array. For example, an interface block 245 may identify an error associated with a counter 380 of a die 240 based on receiving access signaling 410 from an interface block 220. The counter 380 may count activations of a row 405-a of a memory array 250 at the die 240. In some examples, aspects of the operations of 1110 may be performed by an error detection component 930 as described with reference to FIG. 9.

At 1115, the method may include transmitting, from the second interface to the first interface based on identifying the error, second signaling including an indication of the error. For example, an interface block 245 may transmit alert signaling 415 (e.g., via a bus 301) to an interface block 220 based on identifying an error associated with a counter 380. The alert signaling 415 may include an indication of the identified error. In some examples, aspects of the operations of 1115 may be performed by an error signaling component 935 as described with reference to FIG. 9.

At 1120, the method may include receiving, from the first interface based on transmitting the second signaling, third signaling including a second command to refresh one or more second rows of the memory array different from the row. For example, an interface block 245 may receive refresh signaling 420 from an interface block 220 based on transmitting alert signaling 415 to the interface block 220. The refresh signaling 420 may include refresh commands to refresh one or more rows 405-a of a memory array 250 different from a row 405-a associated with the alert signaling. In some examples, aspects of the operations of 1120 may be performed by a refresh signaling component 940 as described with reference to FIG. 9.

In some examples, an apparatus as described herein may perform a method or methods, such as the method 1100. The apparatus may include features, circuitry, logic, means, or instructions (e.g., a non-transitory computer-readable medium storing instructions executable by a processor), or any combination thereof for performing the following aspects of the present disclosure:

Aspect 6: A method, apparatus, or non-transitory computer-readable medium including operations, features, circuitry, logic, means, or instructions, or any combination thereof for receiving, from a first interface of a first semiconductor die at a second interface of a second semiconductor die, first signaling including a first command to activate a row of a memory array of the second semiconductor die; identifying, at the second interface based on the first signaling, an error associated with a counter of the second semiconductor die for counting activations of the row of the memory array; transmitting, from the second interface to the first interface based on identifying the error, second signaling including an indication of the error; and receiving, from the first interface based on transmitting the second signaling, third signaling including a second command to refresh one or more second rows of the memory array different from the row.

It should be noted that the methods described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 7: An apparatus (e.g., a system), including: a first semiconductor die, including: a first interface, the first interface including first circuitry operable to transmit access signaling; and a first counter; and a second semiconductor die coupled with the first semiconductor die, the second semiconductor die including: one or more memory arrays; a second counter; and a second interface coupled with the first interface, the one or more memory arrays, and the second counter, the second interface including second circuitry operable to access the one or more memory arrays based on receiving the access signaling, where the first circuitry of the first interface is operable to transmit refresh signaling to the second interface indicating a refresh operation associated with one or more addresses of the one or more memory arrays based on a quantity of access operations on the one or more memory arrays indicated by the first counter or by the second counter.

Aspect 8: The apparatus of aspect 7, where: the second circuitry of the second interface is further operable to transmit first signaling to the first interface based on receiving the access signaling, the first signaling indicating an error associated with the second counter; and the first circuitry of the first interface is further operable to activate the first counter based on receiving the first signaling.

Aspect 9: The apparatus of aspect 8, where, to activate the first counter, the first circuitry of the first interface is operable to: allocate a portion of a memory array of the first semiconductor die for the first counter; and associate the first counter with an address of the one or more memory arrays that is associated with the second counter.

Aspect 10: The apparatus of aspect 9, where the portion of the memory array is operable as a content-addressable memory.

Aspect 11: The apparatus of any of aspects 8 through 10, where the first circuitry of the first interface is further operable to: transmit, to the second interface after receiving the first signaling, second access signaling to the second interface; increment a value of the first counter based on transmitting the second access signaling; transmit the refresh signaling to the second interface based on the value of the first counter satisfying one or more thresholds; and reset one or more portions of the first counter based on transmitting the refresh signaling.

Aspect 12: The apparatus of any of aspects 8 through 11, where: the second circuitry of the second interface is further operable to transmit, after transmitting the first signaling, second signaling to the first interface indicating that a value of the second counter satisfies a threshold; and the first circuitry of the first interface is further operable to deactivate the first counter based on receiving the second signaling.

Aspect 13: The apparatus of any of aspects 8 through 12, where the first circuitry of the first interface is further operable to: deactivate the first counter based on a value of the first counter failing to satisfy a threshold within a duration.

Aspect 14: The apparatus of aspect 13, where, to deactivate the first counter, the first circuitry of the first interface is operable to: deallocate a portion of a memory array of the first semiconductor die for the first counter; and disassociate the first counter with an address of the one or more memory arrays that is associated with the second counter.

Aspect 15: The apparatus of any of aspects 8 through 14, where the first circuitry of the first interface is further operable to: transmit the refresh signaling based on the first signaling indicating the error associated with the second counter.

Aspect 16: The apparatus of aspect 15, where the second circuitry of the second interface is further operable to: reset one or more portions of the second counter based on the error associated with the second counter.

Aspect 17: The apparatus of any of aspects 7 through 16, where the second circuitry of the second interface is further operable to: read a value of the second counter based on accessing the one or more memory arrays; identify an error associated with the second counter based on reading the value of the second counter; and transmit first signaling to the first interface based on identifying the error, the first signaling indicating the error associated with the second counter.

Aspect 18: The apparatus of aspect 17, where the second circuitry of the second interface is operable to identify the error based on one or more parity bits of the second counter, one or more error detection bits of the second counter, a cyclic redundancy check operation based on an indication of the second counter, or any combination thereof.

Aspect 19: The apparatus of any of aspects 7 through 18, where the first interface includes the first counter of the first semiconductor die.

Aspect 20: The apparatus of any of aspects 7 through 19, where the refresh operation is for a set of one or more addresses different from an address of the one or more memory arrays that is associated with the first counter or the second counter.

An apparatus is described. The following provides an overview of aspects of the apparatus as described herein:

Aspect 21: An apparatus, including: a first semiconductor die including a first interface, the first interface including circuitry operable to: transmit, to a second interface of a second semiconductor die coupled with the first semiconductor die, first signaling including a first command to activate a row of a memory array of the second semiconductor die; receive, from the second interface based on transmitting the first signaling, second signaling indicating an error associated with a first counter of the second semiconductor die for counting activations of the row of the memory array; activate a second counter of the first semiconductor die for counting activations of the row of the memory array based on receiving the second signaling indicating the error; and transmit, to the second interface based on a value of the second counter or the second signaling indicating the error, third signaling including a second command to refresh one or more rows of the memory array different from the row.

Aspect 22: The apparatus of aspect 21, where to activate the second counter, the circuitry is operable to: allocate a portion of a second memory array of the first semiconductor die for the second counter; and associate the second counter with the row.

Aspect 23: The apparatus of any of aspects 21 through 22, where the circuitry is further operable to: transmit, to the second interface after activating the second counter, fourth signaling including a third command to activate the row; increment the value of the second counter based on transmitting the fourth signaling from the second interface; transmit the third signaling to the second interface based on the value of the second counter satisfying one or more thresholds; and reset one or more portions of the second counter based on transmitting the third signaling.

Aspect 24: The apparatus of any of aspects 21 through 23, where the circuitry is further operable to: receive, from the second interface after receiving the second signaling, fourth signaling indicating that a value of the first counter satisfies a threshold; and deactivate the second counter based on receiving the fourth signaling.

Aspect 25: The apparatus of any of aspects 21 through 24, where the circuitry is further operable to: deactivate the second counter based on the value of the second counter failing to satisfy a threshold within a duration.

Aspect 26: The apparatus of any of aspects 21 through 25, where the first interface includes the second counter.

Aspect 27: The apparatus of any of aspects 21 through 26, where the circuitry is operable to transmit the third signaling in response to receiving the second signaling indicating the error, the one or more rows of the memory array different from the row including a first set of rows and a second set of rows different from the first set of rows based on the second signaling indicating the error.

An apparatus is described. The following provides an overview of aspects of the apparatus as described herein:

Aspect 28: An apparatus, including: a second semiconductor die including a second interface, the second interface including circuitry operable to: receive, from a first interface of a first semiconductor die, first signaling including a first command to activate a row of a memory array of the second semiconductor die; identify, based on the first signaling, an error associated with a counter of the second semiconductor die for counting activations of the row of the memory array; transmit, to the first interface based on identifying the error, second signaling including an indication of the error; and receive, from the first interface based on transmitting the second signaling, third signaling including a second command to refresh one or more second rows of the memory array different from the row.

Aspect 29: The apparatus of aspect 28, where the circuitry is further operable to: reset a value of the counter based on transmitting the second signaling to the first interface.

Aspect 30: The apparatus of any of aspects 28 through 29, where the circuitry is further operable to: receive, based on transmitting the second signaling and after receiving the third signaling, fourth signaling including a third command to refresh the one or more second rows while a value of the counter fails to satisfy a threshold.

Aspect 31: The apparatus of any of aspects 28 through 30, where the circuitry is operable to identify the error based on one or more parity bits of the counter, one or more error detection bits of the counter, a cycle redundancy check operation based on an indication of the counter, or any combination thereof.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. At any given time, a conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system, comprising:
a first semiconductor die, comprising:
a first interface, the first interface comprising first circuitry operable to transmit access signaling; and
a first counter; and
a second semiconductor die coupled with the first semiconductor die, the second semiconductor die comprising:
one or more memory arrays;
a second counter; and
a second interface coupled with the first interface, the one or more memory arrays, and the second counter, the second interface comprising second circuitry operable to access the one or more memory arrays based on receiving the access signaling,
wherein the first circuitry of the first interface is operable to transmit refresh signaling to the second interface indicating a refresh operation associated with one or more addresses of the one or more memory arrays based on a quantity of access operations on the one or more memory arrays indicated by the first counter or by the second counter.

2. The system of claim 1, wherein:
the second circuitry of the second interface is further operable to transmit first signaling to the first interface based on receiving the access signaling, the first signaling indicating an error associated with the second counter; and
the first circuitry of the first interface is further operable to activate the first counter based on receiving the first signaling.

3. The system of claim 2, wherein, to activate the first counter, the first circuitry of the first interface is operable to:
allocate a portion of a memory array of the first semiconductor die for the first counter; and
associate the first counter with an address of the one or more memory arrays that is associated with the second counter.

4. The system of claim 3, wherein the portion of the memory array is operable as a content-addressable memory.

5. The system of claim 2, wherein the first circuitry of the first interface is further operable to:
transmit, to the second interface after receiving the first signaling, second access signaling to the second interface;
increment a value of the first counter based on transmitting the second access signaling;
transmit the refresh signaling to the second interface based on the value of the first counter satisfying one or more thresholds; and
reset one or more portions of the first counter based on transmitting the refresh signaling.

6. The system of claim 2, wherein:
the second circuitry of the second interface is further operable to transmit, after transmitting the first signaling, second signaling to the first interface indicating that a value of the second counter satisfies a threshold; and
the first circuitry of the first interface is further operable to deactivate the first counter based on receiving the second signaling.

7. The system of claim 2, wherein the first circuitry of the first interface is further operable to:
deactivate the first counter based on a value of the first counter failing to satisfy a threshold within a duration.

8. The system of claim 7, wherein, to deactivate the first counter, the first circuitry of the first interface is operable to:
deallocate a portion of a memory array of the first semiconductor die for the first counter; and
disassociate the first counter with an address of the one or more memory arrays that is associated with the second counter.

9. The system of claim 2, wherein the first circuitry of the first interface is further operable to:
transmit the refresh signaling based on the first signaling indicating the error associated with the second counter.

10. The system of claim 9, wherein the second circuitry of the second interface is further operable to:
reset one or more portions of the second counter based on the error associated with the second counter.

11. The system of claim 1, wherein the second circuitry of the second interface is further operable to:
read a value of the second counter based on accessing the one or more memory arrays;
identify an error associated with the second counter based on reading the value of the second counter; and
transmit first signaling to the first interface based on identifying the error, the first signaling indicating the error associated with the second counter.

12. The system of claim 11, wherein the second circuitry of the second interface is operable to identify the error based on one or more parity bits of the second counter, one or more error detection bits of the second counter, a cyclic redundancy check operation based on an indication of the second counter, or any combination thereof.

13. The system of claim 1, wherein the first interface comprises the first counter of the first semiconductor die.

14. The system of claim 1, wherein the refresh operation is for a set of one or more addresses different from an address of the one or more memory arrays that is associated with the first counter or the second counter.

15. An apparatus, comprising:
a first semiconductor die comprising a first interface, the first interface comprising circuitry operable to:
transmit, to a second interface of a second semiconductor die coupled with the first semiconductor die, first signaling comprising a first command to activate a row of a memory array of the second semiconductor die;
receive, from the second interface based on transmitting the first signaling, second signaling indicating an error associated with a first counter of the second semiconductor die for counting activations of the row of the memory array;
activate a second counter of the first semiconductor die for counting activations of the row of the memory array based on receiving the second signaling indicating the error; and
transmit, to the second interface based on a value of the second counter or the second signaling indicating the error, third signaling comprising a second command to refresh one or more rows of the memory array different from the row.

16. The apparatus of claim 15, wherein to activate the second counter, the circuitry is operable to:
allocate a portion of a second memory array of the first semiconductor die for the second counter; and
associate the second counter with the row.

17. The apparatus of claim 15, wherein the circuitry is further operable to:
transmit, to the second interface after activating the second counter, fourth signaling comprising a third command to activate the row;
increment the value of the second counter based on transmitting the fourth signaling from the second interface;
transmit the third signaling to the second interface based on the value of the second counter satisfying one or more thresholds; and
reset one or more portions of the second counter based on transmitting the third signaling.

18. The apparatus of claim 15, wherein the circuitry is further operable to:
receive, from the second interface after receiving the second signaling, fourth signaling indicating that a value of the first counter satisfies a threshold; and
deactivate the second counter based on receiving the fourth signaling.

19. The apparatus of claim 15, wherein the circuitry is further operable to:
deactivate the second counter based on the value of the second counter failing to satisfy a threshold within a duration.

20. The apparatus of claim 15, wherein the first interface comprises the second counter.

21. The apparatus of claim 15, wherein the circuitry is operable to transmit the third signaling in response to receiving the second signaling indicating the error, the one or more rows of the memory array different from the row comprising a first set of rows and a second set of rows different from the first set of rows based on the second signaling indicating the error.

22. A method, comprising:
transmitting, from a first interface of a first semiconductor die to a second interface of a second semiconductor die coupled with the first semiconductor die, first signaling comprising a first command to activate a row of a memory array of the second semiconductor die;
receiving, at the first interface from the second interface based on transmitting the first signaling, second signaling indicating an error associated with a first counter of the second semiconductor die for counting activations of the row of the memory array;
activating, at the first interface, a second counter of the first semiconductor die for counting activations of the row of the memory array based on receiving the second signaling indicating the error; and
transmitting, from the first interface to the second interface based on the indication of the error or a value of the second counter, third signaling comprising a second command to refresh one or more rows of the memory array different from the row.

23. The method of claim 22, wherein activating the second counter comprises:
allocating a portion of a second memory array of the first semiconductor die for the second counter; and
associating the second counter with the row.

24. The method of claim 22, further comprising:
transmitting, from the first interface to the second interface after activating the second counter, fourth signaling comprising a third command to activate the row;
incrementing, at the first interface, the value of the second counter based on transmitting the fourth signaling;
transmitting the third signaling from the first interface to the second interface based on the value of the second counter satisfying one or more thresholds; and
resetting, at the first interface, one or more portions of the second counter based on transmitting the third signaling.

25. The method of claim 22, further comprising:
receiving, at the first interface from the second interface after receiving the second signaling, fourth signaling indicating that a value of the first counter satisfies a threshold; and
deactivating, at the first interface, the second counter based on receiving the fourth signaling.

26. The method of claim 22, further comprising:
deactivating, at the first interface, the second counter based on the value of the second counter failing to satisfy a threshold within a duration.

27. An apparatus, comprising:
a second semiconductor die comprising a second interface, the second interface comprising circuitry operable to:
receive, from a first interface of a first semiconductor die, first signaling comprising a first command to activate a row of a memory array of the second semiconductor die;
identify, based on the first signaling, an error associated with a counter of the second semiconductor die for counting activations of the row of the memory array;
transmit, to the first interface based on identifying the error, second signaling comprising an indication of the error; and
receive, from the first interface based on transmitting the second signaling, third signaling comprising a second command to refresh one or more second rows of the memory array different from the row.

28. The apparatus of claim 27, wherein the circuitry is further operable to:
reset a value of the counter based on transmitting the second signaling to the first interface.

29. The apparatus of claim 27, wherein the circuitry is further operable to:
receive, based on transmitting the second signaling and after receiving the third signaling, fourth signaling comprising a third command to refresh the one or more second rows while a value of the counter fails to satisfy a threshold.

30. The apparatus of claim 27, wherein the circuitry is operable to identify the error based on one or more parity bits of the counter, one or more error detection bits of the counter, a cycle redundancy check operation based on an indication of the counter, or any combination thereof.

31. A method, comprising:
receiving, from a first interface of a first semiconductor die at a second interface of a second semiconductor die, first signaling comprising a first command to activate a row of a memory array of the second semiconductor die;
identifying, at the second interface based on the first signaling, an error associated with a counter of the second semiconductor die for counting activations of the row of the memory array;
transmitting, from the second interface to the first interface based on identifying the error, second signaling comprising an indication of the error; and
receiving, from the first interface based on transmitting the second signaling, third signaling comprising a second command to refresh one or more second rows of the memory array different from the row.
